(19) United States
(12) Patent Application Publication
(10) Pub. No.: US 2008/0270744 A1
(43) Pub. Date: Oct. 30, 2008

(54) BUFFER MEMORY SHARING APPARATUS

(76) Inventor: Yoshinobu Hashimoto, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/108,840

(22) Filed: Apr. 24, 2008

(30) Foreign Application Priority Data
Apr. 27, 2007 (JP) 2007-118673

(51) Int. Cl. G06F 12/02

(52) U.S. Cl. 711/217; 711/E12.002

(57) ABSTRACT

The present invention allows a buffer memory to be shared for data streams, while maintaining space efficiency of the buffer memory. A buffer memory sharing apparatus allowing the buffer memory to be shared includes: a flag managing circuit which manages flags each indicating an occupancy status of a region; and, for the each data stream, an address generating circuit. The address generating circuit includes: an occupancy managing circuit which manages exclusive allocation of regions based on the flags; a FIFO memory which stores a bit sequence indicating an allocated region; a write counter; and a read counter. The address generating circuit generates a write address by combining a bit sequence stored at an end of the FIFO memory and a value of the write counter, and generates a read address by combining a bit sequence stored at a start of the FIFO memory and a value of the read counter.

### BACKGROUND OF THE INVENTION

(1) Field of the Invention

The present invention relates to a buffer memory sharing apparatus which allows a ring buffer included in a physical memory of a computer system to be shared for data streams.

(2) Description of the Related Art

In a system for data transmission and reception and the like, generally, a buffer memory is provided on a data transfer path, and data is temporarily buffered. This is for narrowing not only a difference in processing speed between a data transmitting side and a data receiving side but also a difference in a unit of transfer, and is implemented in general semiconductor circuits and network devices.

The buffer memory is a First-In First-Out (FIFO) memory, and is controlled as a ring buffer so that regions are continuously and repeatedly used.

FIG. 1 is a block diagram of a general buffer memory circuit.

The buffer memory circuit shown in the figure includes a buffer memory 101 and a control circuit 102.

The control circuit 102 outputs, to the buffer memory 101, a write request, write data, and a write address that specifies a location to which the write data is written. Then, the control circuit 102 writes the write data to the location in the buffer memory 101 specified by the write address. Moreover, the control circuit 102 outputs, to the buffer memory 101, a read request and at the same time a read address that specifies a location from which read data is read. The buffer memory 101 outputs, as a response, the read data and a signal that indicates validity of the read data.

With these, the data is written to and read from the buffer memory 101. Here, the data may be written and read simultaneously or sequentially. In the case where the data is written and read sequentially, a request signal line, an address line, and a data line may be used collectively in a read process and a write process.

When variable amount ring buffers can be formed dynamically in regions of the buffer memory, it becomes possible that the buffer memory is shared for data streams and that the regions of the buffer memory are used separately according to application. This allows a miniaturization of a circuit size of the buffer memory and an increase in data transfer efficiency to be realized.

As the conventional technique for dynamically forming the variable amount ring buffers on the buffer memory, there are techniques described in Japanese Unexamined Patent Application Laid-Open Publication No. 2002-508125 (hereinafter, referred to as Patent Reference 1), Japanese Unexamined Patent Application Laid-Open Publication No. 2000-330761 (hereinafter, referred to as Patent Reference 2), Japanese Unexamined Patent Application Laid-Open Publication No. 2002-259115 (hereinafter, referred to as Patent Reference 3), and the like. In these techniques, a location to be written and a location to be read are stored beforehand as a write pointer and a read pointer for each data stream, and a value of the write pointer and a value of the read pointer are outputted selectively to the address line at a time of accessing the buffer memory. At this time, a ring buffer region is formed, for the each data stream, on the buffer memory by setting boundary variables and by limiting a range within which a write pointer and a read pointer for the each data stream move in a specific region.

FIG. 2 is a diagram for describing the conventional technique for forming a ring buffer region for the each data stream on the buffer memory. FIG. 2 shows, in the techniques described in Patent References 1 to 3, and the like, write pointers, read pointers, and boundary variables are controlled while holding what kind of a positional relation between them at a time of forming ring buffers on the buffer memory. Here, an example where three ring buffers are formed on the buffer memory is shown.

As shown in FIG. 2, as a buffer memory 201 is controlled in a ring buffer type, it is shown as a doughnut shape here. The buffer memory 201 is divided into three ring buffer regions by boundary variables 202, 203, and 204 characterizing the conventional technique. The three divided regions can be, for example, allocated to three data streams respectively.

Write pointers 205, 206, and 207 update addresses of locations to which data is to be written in each region, and store the updated addresses. Values of the write pointers are outputted to the address line at a time of writing the data to the buffer memory. Read pointers 208, 209, and 210 update addresses of locations from which data is to be read in the each region, and store the updated addresses. Values of the read pointers are outputted to the address line at a time of reading the data from the buffer memory.

Here, it is assumed that the data is written and read clockwise. The write pointers 205, 206, and 207 are incremented every time the data is written to each region. Likewise, the read pointers 208, 209, and 210 are incremented every time the data is read from each region. Locations indicated by these write pointers and read pointers move clockwise in each ring buffer region partitioned by the boundary variables 202, 203, and 204. For instance, in the case where the write pointer 205 is getting incremented and a location indicated by the write pointer 205 reaches a location indicated by the boundary variable 203, a value of the write pointer 205 is updated to a value of the boundary variable 202 and the location indicated by the write pointer 205 gets lapped to a location indicated by the boundary variable 202. The same applies to the write pointers 206 and 207, and the read pointers 208, 209, and 210. Furthermore, the write pointers and the read pointers are controlled so that overflow or underflow does not occur.

Values of the boundary variables 202, 203, and 204 are updated so that a size of the ring buffer-regions is changed, and the locations indicated by the boundary variables move clockwise or counterclockwise. In the techniques described in Patent References 1 and 2, when an amount of data held in the ring buffer regions increases and a region to be written is used up, a value of a boundary variable is updated so that a location indicated by the boundary variable that partitions a ring buffer region moves in a direction of a next region, and the ring buffer region is expanded. At this time, in the case where the region cannot be expanded because a write pointer or a read pointer of the next region obstructs, the expansion of the region is held until a location indicated by the write pointer or the read pointer of the next region moves. In the technique described in Patent Reference 3, a value of a boundary variable is frequently updated according to an amount of data held in and an amount of data to be inputted to each ring buffer region.

As stated above, in the techniques described in Patent References 1 to 3, the ring buffer regions are formed on the buffer memory as continuous regions. By contrast, as the conventional technique for enabling expansion of a ring buffer region to unused regions located distantly, there is the technique described in Japanese Unexamined Patent Application Laid-Open Publication No. 5-341957 (hereinafter, referred to as Patent Reference 4). In this technique also, a location to be written and a location to be read are stored beforehand as a write pointer and a read pointer, and a value of the write pointer and a value of the read pointer are outputted to the address line at a time of accessing the buffer memory. In addition, a start address and an end address are stored beforehand for each of the regions located distantly.

FIG. 3 is a diagram for describing the technique described in Patent Reference 4 for using regions located distantly in a buffer memory as one ring buffer region. FIG. 3 shows a write pointer, a read pointer, start addresses, and end addresses are controlled while holding what kind of a positional relation between them. Here, an example where three regions located distantly in the buffer memory are used as one ring buffer region.

As shown in FIG. 3, as a buffer memory 301 is controlled in a ring buffer type, it is shown as a doughnut shape here. The buffer memory 301 is divided into three regions located distantly characterizing the conventional technique by start addresses 302, 303, and 304 as well as end addresses 305, 306, and 307. Here, the three regions located distantly are allocated to one data stream. A write pointer 308 updates an address of a location to which data is to be written, and stores the updated address. A value of the write pointer 308 is outputted to the address line at a time of writing the data to the buffer memory. A read pointer 309 updates an address of a location to which data is to be read in each region, and stores the updated address. A value of the read pointer 309 is outputted to the address line at a time of reading the data from the buffer memory.

Here, as shown in FIG. 3, it is assumed that a location indicated by the write pointer 308 is in a region partitioned by the start address 303 and the end address 306, and that a location indicated by the read pointer 309 is in a region partitioned by the start address 302 and the end address 305. Moreover, it is assumed that the write pointer and the read pointer move clockwise. At this time, as the writing of data proceeds and the location indicated by the write pointer 308 reaches a location indicated by the end address 306, the value of the write pointer 308 is updated to a value of the start address 304 in a next region. Similarly, as the reading of data proceeds and the location indicated by the read pointer 309 reaches a location indicated by the end address 305, the value of the read pointer 309 is updated to a value of the start address 303 in a next region.

In the technique described in Patent Reference 4, the above control is performed so as to allow the regions located distantly to be used as one ring buffer region.

Nevertheless, the above-mentioned techniques have the following problems.

First, in the techniques described in Patent References 1 to 3, there is a major problem that a movement of a boundary variable is confined by a location indicated by a write pointer or a read pointer.

For example, in the case where expansion of the region bounded by the boundary variables 202 and 203 shown in FIG. 2 is desired, the region can be expanded by moving the boundary variable 203 clockwise. However, the boundary variable 203 cannot overtake the read pointer 209. This is for preventing deletion of data held in the region bounded by the read pointer 209 and the write pointer 206 before the data is read.

In other words, even when moving a location of a boundary variable is attempted so that free space in a next ring buffer region is to be used, in the case where a write pointer or a read pointer is located near the boundary variable, expansion or contraction of a ring buffer region is not possible. In this case, as the writing and reading of data proceed, it becomes necessary that the location of the write pointer or the read pointer moves away from the location of the boundary variable, and the expansion or the contraction of the region is held until such a condition is satisfied.

Furthermore, in the techniques described in Patent References 1 to 3, the ring buffer regions are ensured as continuous regions. As a result, once the location of the write pointer has been lapped, an operation of the write pointer is confined by the read pointer until the location of the read pointer gets lapped subsequently, and even when the free space in the next ring buffer region newly becomes available, it is impossible to write data there by expanding the region.

For these reasons, it is highly possible that unusable huge free space is idled for a long time, and space efficiency of the buffer memory can be increased only in the case where conditions are satisfied by chance. In addition, since the space efficiency of the buffer memory is high or low depending on current circumstances, it becomes very difficult to estimate transfer performance of each data stream.

Moreover, although the technique described in Patent Reference 4 aims at controlling the regions located distantly as one ring buffer, it can be applied to a case where a buffer memory is shared for data streams. In this case, unlike the techniques described in Patent References 1 to 3, a major advantage arises in that the ring buffer region can be expanded to free space in the buffer memory without being confined by the location of the read pointer or the write pointer.

Nonetheless, as the data streams come to occupy the free space in the buffer memory little by little and intricately, not only management of the free space in the buffer memory and occupied spaces in regions is complex but also control of them becomes difficult. In addition, a calculation of a size of the ring buffer region for each data stream or of free space requires computing resources or control and computation by a Central Processing Unit (CPU). Furthermore, estimation of transfer performance of each data stream also becomes difficult.

It should be noted that, as the advantage of the technique described in Patent Reference 4, it can be pointed out that the ring buffer region can be expanded no matter which size the free space has. However, when free space to be used is set aside big in expanding the ring buffer region, the space efficiency of the buffer memory decreases. Conversely, when it is set aside small, resources for managing regions such as a start address and an end address increase and, as mentioned above, the management of the free space in the buffer memory gets complex.

For the above-mentioned reasons, in the technique described in Patent Reference 4, there is the problem that the management of the free space in the buffer memory requires intricate control and computation. Thus, in the case where the buffer memory is shared for the data streams, it is not wise to apply the technique described in Patent Reference 4.

### SUMMARY OF THE INVENTION

The present invention aims at solving the above-mentioned conventional problems, and has an object of providing a buffer memory sharing apparatus which can realize, when a buffer memory is shared for data streams, dynamic and flexible allocation of regions to the data streams while maintaining space efficiency of the buffer memory with simple control.

In order to solve the conventional problems, the buffer memory sharing apparatus according to the present invention is a buffer memory sharing apparatus which performs control so that the buffer memory is shared for the data streams and which includes: a flag managing unit which manages flags each of which indicates an occupancy status of a corresponding one of regions obtained by dividing the buffer memory; an occupancy managing unit which manages exclusive allocation of the regions to the data streams, based on the flags; and an address generating unit which generates a write address that specifies a location in the buffer memory to which data is written and a read address that specifies a location in the buffer memory from which data is read, wherein the address generating unit includes, in association with each the data streams: a first FIFO memory which stores information regarding a first bit sequence indicating a region allocated by the occupancy managing unit among first bit sequences each of which indicates a location of a corresponding one of the regions; a write counter which outputs a second bit sequence indicating a location to which data is written, the location being in a corresponding one of the regions; and a read counter which outputs a third bit sequence indicating a location from which data is read, the location being in a corresponding one of the regions, and the address generating unit generates the write address by combining the second bit sequence and the first bit sequence obtained from the information stored at an end of the first FIFO memory and generates the read address by combining the third bit sequence and the first bit sequence obtained from the information stored at a start of the first FIFO memory.

With this, the dynamic and flexible allocation of regions to the data streams, while maintaining the space efficiency of the buffer memory, can be realized with the simple control.

Furthermore, the first FIFO memory may store at least one of the first bit sequences indicating the region allocated by the occupancy managing unit among the first bit sequences, and the address generating unit may generate the write address by combining the second bit sequence and the first bit sequence stored at the end of the first FIFO memory and may generate the read address by combining the third bit sequence and the first bit sequence stored at the start of the first FIFO memory.

With this, the dynamic and flexible allocation of regions to the data streams, while maintaining the space efficiency of the buffer memory, can be realized with the simple control.

Moreover, the occupancy managing unit may cause the first FIFO memory to store one of the first bit sequences corresponding to a flag indicating an unoccupied state, in the case where writing of data to the region is completed, and the flag managing unit may change, to an occupied state, the flag corresponding to the first bit sequence stored in the first FIFO memory.

With this, when the writing of data to the buffer memory is completed, since a new region is occupied, a region is not occupied more than necessary. As a result, the space efficiency of the buffer memory can be improved.

In addition, the occupancy managing unit further may cause the first FIFO memory to store one of the first bit sequences corresponding to the flag indicating the unoccupied state, in the case where there is data to be written.

With this, since a new region is occupied for the first time when writing of new data needs to be performed after the writing of data is completed, a region is not occupied more than necessary. As a result, the space efficiency of the buffer memory can be improved.

Furthermore, the write counter may increment a counter value every time the data is written to the region, repetitively increment from zero in the case where the counter value reaches a maximum value, and output the counter value as the second bit sequence, and the occupancy managing unit may cause the first FIFO memory to store one of the first bit sequences corresponding to the flag indicating the unoccupied state, in the case where the counter value of the write counter is zero and there is data to be written.

With this, the completion of the writing of data can be judged based on the counter value, and thus the allocation of regions can be performed with the simple control.

Moreover, the address generating unit may combine the first bit sequence stored in the first FIFO memory by the occupancy managing unit and the counter value of the write counter, in the case where the counter value of the write counter is zero, and may combine the first bit sequence stored at the end of the first FIFO memory and the counter value of the write counter, in the case where the counter value of the write counter is not zero.

With this, writing of a value of a bit sequence indicating a region to the FIFO memory and writing of data of a data stream to the buffer memory can be simultaneously performed, and thus a processing speed can be improved.

Additionally, the occupancy managing unit may output flag update information for changing, to an unoccupied state, a flag corresponding to the region, in the case where reading of data from the region is completed, and the flag managing unit may change the flag to the unoccupied state, in the case where the flag update information is received.

With this, the occupied region can be immediately opened after the writing of data to the buffer memory is completed, and thus the space efficiency of the buffer memory can be improved.

Furthermore, the read counter may increment a counter value every time the data is read from the region, repeat increment from zero in the case where the counter value reaches a maximum value, and output the counter value as the third bit sequence, and the occupancy managing unit may output the flag update information, in the case where the counter value of the read counter becomes zero.

With this, the completion of the reading of data can be judged based on the counter value, and thus the allocation of regions can be performed with the simple control.

Moreover, the write counter may increment a counter value every time the data is written to a first region which is one of the regions, repeat increment from zero in the case where the counter value reaches a maximum value, and output the counter value as the second bit sequence. The read counter may increment a counter value every time the data is read from a second region which is one of the regions, repeat increment from zero in the case where the counter value reaches a maximum value, and output the counter value as the third bit sequence. The occupancy managing unit may cause the first FIFO memory to store one of the first bit sequences corresponding to a flag indicating an unoccupied state, in the case where the counter value of the write counter is zero and there is data to be written, and may output flag update information for changing, to an unoccupied state, a flag corresponding to the second region, in the case where the counter value of the read counter becomes zero. The flag managing unit may change, to an occupied state, a flag corresponding to the first bit sequence stored in the first FIFO memory, and may change, to an unoccupied state, a flag corresponding to the second region in the case where the flag update information is received.

With this, the writing and reading of data, while maintaining the space efficiency of the buffer memory, can be realized with the simple control.

In addition, the buffer memory sharing apparatus further includes an occupancy limiting unit which limits the number of regions to be allocated to the data stream, wherein the occupancy managing unit may manage the allocation based on the number of regions to be allocated.

With this, estimation of a transfer performance of the buffer memory and the like can be performed easily.

Furthermore, the occupancy limiting unit may dynamically determine a minimum number of regions that can be occupied for each data stream, and the occupancy managing unit may manage the exclusive allocation of the regions so as to ensure the minimum number determined for each data stream.

With this, as the minimum number of regions can be ensured for a data stream at any time, the estimation of the transfer performance of the buffer memory and the like can be performed easily.

Moreover, the buffer memory sharing apparatus further includes a lap control unit which outputs a lap permission notification for controlling writing of data to a region including a location specified by the read address, wherein the occupancy managing unit causes the first FIFO memory to store a first bit sequence indicating the region including the location specified by the read address, in the case where the lap permission notification is received.

With this, the space efficiency of the buffer memory can be further improved.

Additionally, the address generating unit may suspend an output by the write counter, in the case where the second bit sequence outputted from the write counter becomes equal to a third bit sequence outputted from the read counter.

With this, while maintaining the space efficiency of the buffer memory, lapping of data that has not been read can be prevented.

Moreover, the first FIFO memory is controlled as a ring buffer having a read pointer which indicates a location from which data is read and a write pointer which indicates a location to which data is written, and the address generating unit may generate the write address by combining the second bit sequence and the first bit sequence stored at a location immediately previous to a location indicated by the write pointer of the first FIFO memory and may generate the read address by combining the third bit sequence and the first bit sequence stored at a location indicated by the read pointer of the first FIFO memory.

Furthermore, the buffer memory sharing apparatus further includes second FIFO memories each of which stores at least one of the first bit sequences, wherein the flag managing unit may further manage FIFO flags each of which indicates an occupancy status of a corresponding one of the corresponding second FIFO memories, the occupancy managing unit may further manage exclusive allocation of the second FIFO memories to the data streams, based on the FIFO flags, the first FIFO memory stores, among plural identification information of the second FIFO memories, identification information allocated by the occupancy managing unit, and the address generating unit may generate the write address and the read address based on the identification information stored in the first FIFO memory.

With this, especially in the case where the number of data streams for which the buffer memory is shared is large and the like, the memory resources necessary for allocating the regions can be reduced.

In addition, the address generating unit may generate the write address by combining the second bit sequence and the first bit sequence stored at an end of the second FIFO memory indicated by identification information stored at an end of the first FIFO memory and may generate the read address by combining the third bit sequence and the first bit sequence stored at a start of the second FIFO memory indicated by the identification information stored at a start of the first FIFO memory.

Moreover, the first bit sequence may include an uppermost bit of the write address and the read address and may be made up of bits continuing from the uppermost bit.

Furthermore, a part of or all components making up each of the above buffer memory sharing apparatuses may be made up by one system Large Scale Integration (LSI).

Additionally, the present invention can also be realized as a communication device. That is, the communication device which transmits and receives data streams includes: a control circuit which transmits and receives the data streams; and a buffer memory which temporally stores the data streams received by the control circuit, wherein the control circuit includes: a flag managing unit which manages flags each of which indicates an occupancy status of a corresponding one of regions obtained by dividing the buffer memory; an occupancy managing unit which manages exclusive allocation of the regions to the data streams, based on the flags; and an address generating unit which generates a write address that specifies a location in the buffer memory to which data is written and a read address that specifies a location in the buffer memory from which data is read, the address generating unit includes, in association with each of the data streams: a first FIFO memory which stores information regarding a first bit sequence indicating a region allocated by the occupancy managing unit among first bit sequences each of which indicates a location of one of the regions; a write counter which outputs a second bit sequence indicating a location to which data is written, the location being in a corresponding one of the regions; and a read counter which outputs a third bit sequence indicating a location from which data is read, the location being in a corresponding one of the regions, and the address generating unit generates the write address by combining the second bit sequence and the first bit sequence obtained from the information stored at an end of the first FIFO memory and generates the read address by combining the third bit sequence and the first bit sequence obtained from the information stored at a start of the first FIFO memory.

According to the present invention, it is possible to dynamically form, on the same buffer memory, variable amount ring buffers corresponding to data streams respectively while maintaining high space efficiency of the buffer memory. Moreover, a buffer memory region can be always allocated to each of the data streams with simple control. This allows a reduction of the buffer memory region, improvement of transfer performance of a system, and simplification in controlling the buffer memory.

### FURTHER INFORMATION ABOUT TECHNICAL BACKGROUND TO THIS APPLICATION

The disclosure of Japanese Patent Application No. 2007-118673 filed on Apr. 27, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing a structure of a general buffer memory circuit;

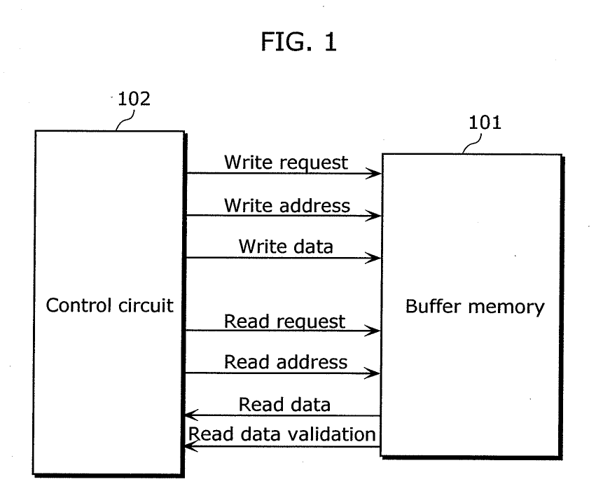

FIG. 2 is a diagram showing a positional relation between pointers and boundary variables in controlling a conventional ring buffer;

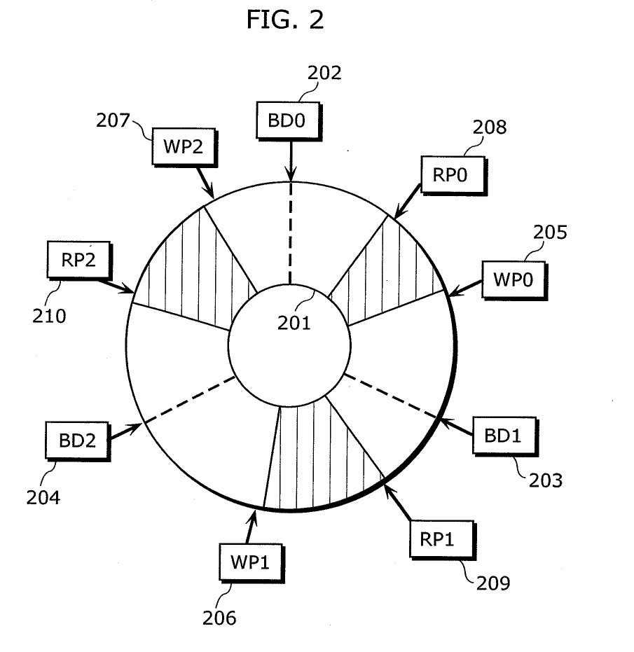

FIG. 3 is a diagram showing a positional relation between pointers, start addresses, and end addresses in controlling a conventional ring buffer;

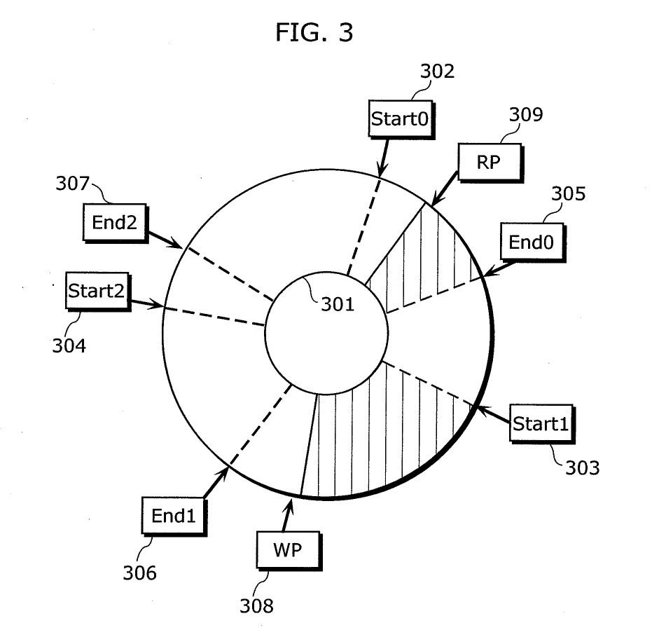

FIG. 4 is a block diagram showing a structure of a buffer memory sharing apparatus according to a first embodiment;

FIG. 5 is a block diagram showing a structure of a ring buffer generating circuit according to the first embodiment;

FIG. 6 is a block diagram showing a structure of an address generating circuit A according to the first embodiment;

FIG. 7 is a diagram for describing an operation of the buffer memory sharing apparatus according to the first embodiment;

FIG. 8 is a diagram for describing an operation regarding generation of a read address and opening of a region;

FIG. 9 is a diagram for describing an operation regarding generation of a write address and occupancy of a region;

FIG. 10 is a block diagram showing a structure of a buffer memory sharing apparatus according to a second embodiment;

FIG. 11 is a block diagram showing a structure of a ring buffer generating circuit according to the second embodiment;

FIG. 12 is a block diagram showing a structure of an address generating circuit A according to the second embodiment;

FIG. 13 is a diagram showing an example of the number of occupiable regions limited for each data stream;

FIG. 14 is a diagram for describing an operation in the case where the number of occupiable regions limited for each data stream is changed dynamically;

FIG. 15 is a block diagram showing a structure of a buffer memory sharing apparatus according to a third embodiment;

FIG. 16 is a block diagram showing a structure of a ring buffer generating circuit according to the third embodiment;

FIG. 17 is a block diagram showing a structure of an address generating circuit A according to the third embodiment;

FIG. 18 is a block diagram for describing an operation of the buffer memory sharing apparatus according to the third embodiment;

FIG. 19 is a block diagram showing a structure of a FIFO memory of the buffer memory sharing apparatus according to a fourth embodiment; and

FIG. 20 is a block diagram showing a structure of a communication device including the buffer memory sharing apparatus of the present invention.

### DESCRIPTION OF THE PREFERRED EMBODIMENT(S)

The following describes embodiments of the present invention with reference to the drawings. It should be noted that a clock signal used by illustrated logic circuits for synchronization is not described in a series of the drawings.

### First Embodiment

A buffer memory sharing apparatus of the first embodiment is an apparatus which exclusively allocates, to each data stream, regions obtained by dividing a buffer memory and which includes, for the each data stream, a FIFO memory that manages each of the allocated regions so that the buffer memory is shared for the data streams.

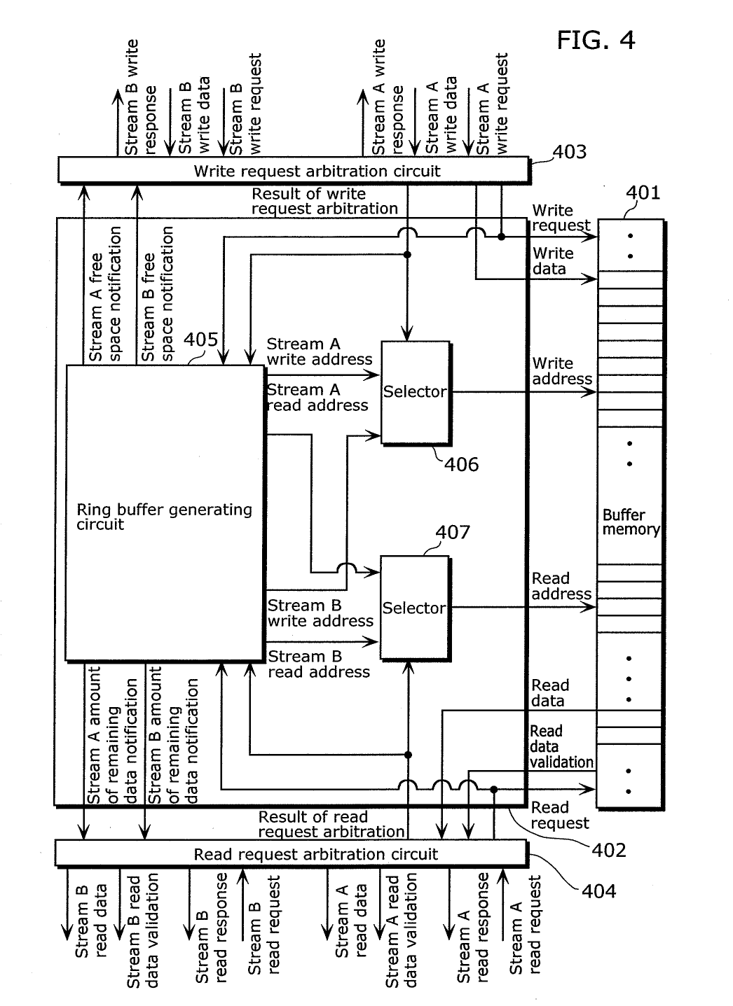

FIG. 4 is a block diagram showing a structure of a buffer memory sharing apparatus according to the present embodiment.

The buffer memory sharing apparatus forms a ring buffer region on a buffer memory 401, and the buffer memory 401 is shared for data steams. The buffer memory sharing apparatus includes a control circuit 402, a write request arbitration circuit 403, and a read request arbitration circuit 404.

The buffer memory 401 is a dual port Random Access Memory (RAM) which can be read and written simultaneously. Moreover, in the present embodiment, it is assumed that the RAM has 1024 (=2¹⁰) locations and specifies a location to be written and a location to be read with a 10-bit address, and that a data bus width is 32 bits. It should be noted that the buffer memory of the present embodiment is not limited to the dual port RAM, and that capacity of the buffer memory and the data bus width are also not limited.

In the present embodiment, a case where discrete ring buffer regions are formed for two data streams, data stream A and data stream B, and the buffer memory 401 is shared for the two data streams will be described.

The control circuit 402 controls writing and reading of data to and from the buffer memory 401.

The control circuit 402 outputs, to the buffer memory 401, a write request, 32-bit width write data, and a 10-bit write address that specifies a location to which the write data is written. Then, the control circuit 402 writes the write data to the location specified by the write address.

The control circuit 402 outputs, to the buffer memory 401, a read request and at the same time a 10-bit read address that specifies a location from which 32-bit width read data is read.

The control circuit 402 receives, from the buffer memory 401, the read data and a signal which indicates that the read data is valid, in response to the read request. With these, the data is written to and read from the buffer memory 401 are performed.

The write request arbitration circuit 403 receives a write request and write data of the data stream A and a write request and write data of the data stream B. In addition, the write request arbitration circuit 403 receives a notification of free space for the data of the data stream A and the data of the data stream B that can be written. The write request arbitration circuit 403 judges, from the notification of free space, whether or not the data of the data stream A and the data of the data stream B can be written, and performs arbitration in accordance with an arbitration policy. At this time, in the case where the write request of the data stream A is arbitrated, a write response of the data stream A is outputted. In the case where the write request of the data stream B is arbitrated, a write response of the data stream B is outputted. At the same time, an arbitration result, the arbitrated write request, and the arbitrated write data are outputted to the control circuit 402. It should be noted that, although the present embodiment describes an example where the data is written once per arbitration, the data may be written several times successively per arbitration.

The read request arbitration circuit 404 receives a read request of the data stream A and a read request of the data stream B. Moreover, the read request arbitration circuit 404 receives a notification of amount of remaining data of the data stream A and the data stream B that can be read. The read request arbitration circuit 404 judges, from the notification of amount of remaining data, whether or not the data of the data stream A and the data of the data stream B can be read from the buffer memory 401, and performs arbitration in accordance with an arbitration policy. At this time, in the case where the read request of the data stream A is arbitrated, a read response of the data stream A is outputted. In the case where the read request of the data stream B is arbitrated, a read response of the data stream B is outputted. At the same time, an arbitration result and the arbitrated read request are outputted to the control circuit 402. The read request arbitration circuit 404 receives, from the control circuit 402, the read data and a notification that the read data is valid. In the case where the read data is for the read request of the data stream A, a read data validation and the read data of the data stream A are outputted. In the case where the read data is for the read request of the data stream B, a read data validation and the read data of the data stream B are outputted. It should be noted that, although the present embodiment describes an example where the data is read once per arbitration, the data may be read several times successively per arbitration.

Next, a structure of the control circuit 402 will be described in detail. As shown in FIG. 4, the control circuit 402 includes a ring buffer generating circuit 405 and selectors 406 and 407 so as to perform the above-mentioned process.

The ring buffer generating circuit 405 is a circuit which has a function characterizing the present invention.

The ring buffer generating circuit 405 generates a write address and a read address at a time of dynamically forming respective ring buffer regions on the buffer memory 401 for the data stream A and the data stream B.

In other words, the ring buffer generating circuit 405 is a circuit which generates the write address and the read address so that one ring buffer region can be formed on the buffer memory 401 for the data stream A and the data stream B respectively, using mutually different regions.

The selector 406 selects the write address of the data stream A and the write address of the data stream B both outputted from the ring buffer generating circuit 405 according to the arbitration result outputted from the write request arbitration circuit 403, and outputs them as a write address to the buffer memory 401, at a time of outputting the write request to the buffer memory 401.

The selector 407 selects the read address of the data stream A and the read address of the data stream B both outputted from the ring buffer generating circuit 405 according to the arbitration result outputted from the read request arbitration circuit 404, and outputs them as a read address to the buffer memory 401, at a time of outputting the read request to the buffer memory 401.

With the above structure, the variable amount ring buffer is to be formed on the buffer memory 401 respectively for the data stream A and the data stream B.

Next, the ring buffer generating circuit 405 will be described in detail.

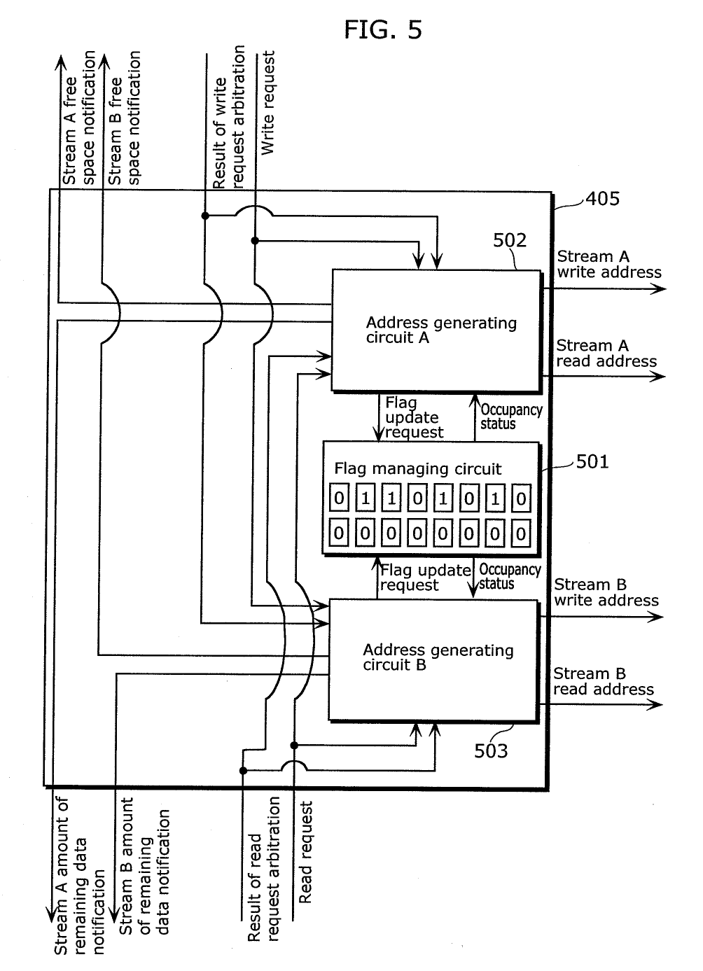

FIG. 5 is a block diagram showing a structure of the ring buffer generating circuit 405 characterizing the present invention.

It should be noted that an address to be outputted to the buffer memory 401 is 10 bits in the present embodiment. As an example, among the 10 bits, upper 4 bits continuing from the uppermost bit are assumed as a partial bit sequence, and it is assumed that values which the partial bit sequence can indicate are exclusively occupied by the data stream A and the data stream B. At this time, since the partial bit sequence is the upper 4 bits, exclusively occupying the values of the partial bit sequence is equivalent to divide the buffer memory 401 into 16 equal parts as continuous regions and to exclusively occupy the regions that are divided into 16 equal parts.

It should be noted that 4 bits to be occupied do not need to continue from the uppermost bit, and may be selected from any bits. For example, it is possible to select the bits discretely, such as 1 bit from the upper bits, 1 bit from the middle bits, and 2 bits from the lower bits. In this case, although the discretely selected bits are not continuous regions, dividing the buffer memory 401 into 16 equal parts and exclusively occupying them per se are same. Furthermore, a bit width of the partial bit sequence is not limited to 4 bits, and it may be, for example, 3 bits or 5 bits. In the case of 3 bits, a buffer memory is to be divided into 8 equal parts, and in the case of 5 bits, it is to be divided into 32 equal parts. Moreover, the ring buffer generating circuit 405 may be structured so that these division numbers are dynamically changed with setting by an external control circuit, such as the CPU.

As shown in FIG. 5, the ring buffer generating circuit 405 includes a flag managing circuit 501, an address generating circuit A 502, and an address generating circuit B 503.

The flag managing circuit 501 has 16 flags for reflecting occupancy statuses for the values that the upper 4-bit partial bit sequence can indicate. That is to say, the flag managing circuit 501 holds and manages flags each of which reflects the occupancy status of one of equal-sized regions where the values of the upper 4 bits on the address line are accessed with 0000, 0001, 0010, 0011, 0100, 0101, 0110, 0111, 1000, 1001, 1010, 1011, 1100, 1101, 1110, and 1111. The flag managing circuit 501 outputs the occupancy status of one of the regions to the address generating circuit A 502 and the address generating circuit B 503. In addition, upon receiving a flag update request from the address generating circuit A 502 and the address generating circuit B 503, a value of a flag is changed to an occupied state or an unoccupied state. Note that, in FIG. 5, a numeric value 1 denotes the occupied state, and a numeric value 0 denotes the unoccupied state.

The address generating circuit A 502 receives the write request and the write request arbitration result from the write request arbitration circuit 403 and the read request and the read request arbitration result from the read request arbitration circuit 404. Then, in the case where the data stream A is read or written, the write address that specifies the location to which the data of the data stream A is written and the read address that specifies the location from which the data of the data stream A is read are updated respectively.

The address generating circuit A 502 references the occupancy status outputted from the flag managing circuit 501, and outputs, to the flag managing circuit 501, a flag update request for changing a flag corresponding to a region to be occupied (flag for occupancy) to the occupied state in the case where an unoccupied region is to be newly occupied. In the case where a region is to be opened after data in the occupied region is read, a flag update request for changing a flag corresponding to the region to be opened (flag for opening) to the unoccupied state is outputted. It should be noted that, although the flag update request is represented as a single signal line in FIG. 5, it is actually made up by a signal line for requesting occupancy, a signal line for requesting opening, a signal line for specifying a flag for occupancy, and a signal line for specifying a flag for opening.

Furthermore, the address generating circuit A 502 calculates free space to which the data stream A can be written based on the occupancy status received from the flag managing circuit 501 and internal control information of the address generating circuit A 502, and outputs the calculated free space to the write request arbitration circuit 403. In addition, an amount of data of the data stream A in the buffer memory 401 is calculated based on the internal control information, and the calculated amount is outputted to the read request arbitration circuit 404.

It should be noted that, since the flag managing circuit 501 always outputs the occupancy status of each region, the address generating circuit A 502 and the address generating circuit B 503 each can obtain an unoccupied region at once as necessary. Accordingly, in the case where the region is obtained by either the address generating circuit A 502 or the address generating circuit B 503, the flag managing circuit 501 may change the flag corresponding to the obtained region to the occupied state. This allows obtaining the region and changing the flag to be performed at the same time, and thus it is possible to increase the processing speed.

Likewise, the address generating circuit B 503 receives the write request and the write request arbitration result from the write request arbitration circuit 403 and the read request and the read request arbitration result from the read request arbitration circuit 404. Then, in the case where the data stream B is read or written, the write address that specifies the location to which the data of the data stream B is written and the read address that specifies the location from which the data of the data stream B is read are updated respectively.

The address generating circuit B 503 references the occupancy status outputted from the flag managing circuit 501, and outputs a flag update request for changing a flag corresponding to a region to be occupied to the occupied state in the case where an unoccupied region is to be newly occupied. In the case where a region is to be opened after data in the occupied region is read, a flag update request for changing a flag corresponding to the region to be opened to the unoccupied state is outputted. It should be noted that, although the flag update request is represented as a single signal line in FIG. 5, it is actually made up by a signal line for requesting occupancy, a signal line for requesting opening, a signal line for specifying a flag for occupancy, and a signal line for specifying a flag for opening.

Moreover, the address generating circuit B 503 calculates free space to which the data stream B can be written based on the occupancy status received from the flag managing circuit 501 and internal control information of the address generating circuit B 503, and outputs the calculated free space to the write request arbitration circuit 403. Additionally, an amount of data of the data stream B in the buffer memory 401 is calculated based on the internal control information, and the calculated amount is outputted to the read request arbitration circuit 404.

Next, the address generating circuit A 502 and the address generating circuit B 503 will be described in detail. It should be noted that, as respective structures of the address generating circuit A 502 and the address generating circuit B 503 are same, only the former will be described here.

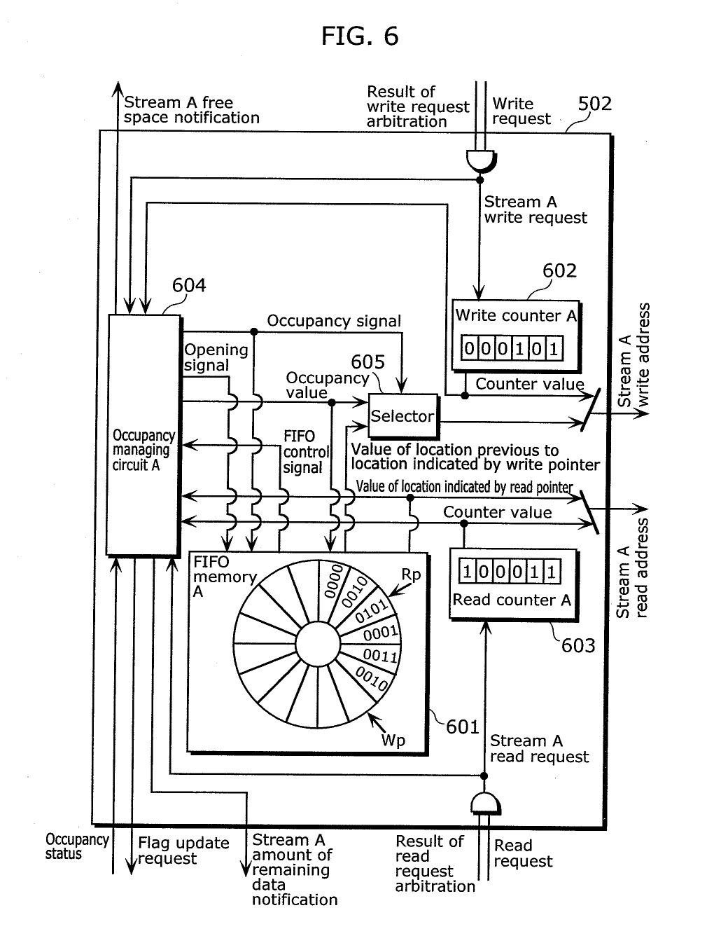

FIG. 6 is a block diagram showing the structure of the address generating circuit A 502.

As shown in FIG. 6, the address generating circuit A 502 includes a FIFO memory A 601, a write counter A 602, a read counter A 603, an occupancy managing circuit A 604, and a selector 605.

The FIFO memory A 601 is a FIFO memory in which the values of the partial bit sequence to be occupied by the data stream A, that is, an equal-sized region to be occupied is stored. In the present embodiment, it is assumed that the FIFO memory A 601 is a FIFO memory which is controlled in a ring buffer type and in which a location to be written and a location to be read are specified by a write pointer and a read pointer. Stated differently, a start of the FIFO memory is a location specified by the read pointer, and an end of the FIFO memory is a location immediately previous to a location specified by the write pointer.

Moreover, the FIFO memory A 601 is assumed to be structured with a flip-flop, and it is assumed that, although writing of data requires one cycle, reading of data needs no temporal costs. Furthermore, in the case where an upper limit of the number of values of a partial bit sequence that may be occupied is known in advance, as shown in FIG. 6, there is no need to have enough number of regions for holding all of the 16 values. In addition, as long as the FIFO memory A 601 operates as the FIFO memory, it does not need to be a single memory. For example, it may be included in the same memory as a FIFO memory in which an occupied region of the data stream B is stored.

The FIFO memory A 601 receives, from the occupancy managing circuit A 604, an occupancy signal, an occupancy value, and an opening signal. The occupancy value is stored based on the occupancy signal, and the write pointer is incremented. At this time, the occupancy value is one of the values that a partial bit sequence can indicate, and is a 4-bit value. Moreover, the read pointer is incremented based on the opening signal.

The FIFO memory A 601 outputs, to the occupancy managing circuit A 604, a value held in a location specified by the read pointer. In addition, the FIFO memory A 601 outputs, to the selector 605, a value held in a location immediately previous to a location specified by the write pointer. It should be noted that the value held in the location specified by the read pointer is used as an upper 4-bit value of a read address when data of the data stream A is read from the buffer memory 401. The value held in the location immediately previous to the location specified by the write pointer is used as an upper 4-bit value of a write address when data of the data stream A is written to the buffer memory 401.

The FIFO memory A 601 outputs, to the occupancy managing circuit A 604, a FIFO control signal including information regarding the write pointer and the read pointer, a flag which indicates a lap status of the write pointer, and a flag which indicates a lap status of the read pointer. Note that the flag which indicates the lap status of the write pointer or the read pointer is a 1-bit signal which inverts every time the write pointer or the read pointer laps the ring buffer. In the case where the write pointer and the read pointer are in the same lap, they show the same value, and in the case where the write pointer laps the read pointer, they each show an inverted value. In the case where the write pointer and the read pointer are in the same lap, the read pointer cannot lap the write pointer. Moreover, in the case where the write pointer laps the read pointer, the write pointer cannot lap the read pointer. The flag which indicates the lap status is used to judge restriction on the above-mentioned movements of the write pointer and the read pointer.

The write counter A 602 is incremented every time the data of the data stream A is written to the buffer memory 401 based on a write request. At this time, it is judged whether the write request is the write request of the data stream A from the write request and the write request arbitration result of the write request arbitration circuit 403. For example, when a value 1 of the write request arbitration result indicates that the write request of the data stream A has been arbitrated, as shown in FIG. 6, it is only necessary to calculate AND between the write request and the write request arbitration result. Note that the judgment may be made at earlier stages.

The read counter A 603 is incremented every time the data of the data stream A is read from the buffer memory 401 based on a read request. At this time, it is judged whether the read request is the read request of the data stream A from the read request and the read request arbitration result of the read request arbitration circuit 404. For example, when a value 1 of the read request arbitration result indicates that the read request of the data stream A has been arbitrated, as shown in FIG. 6, it is only necessary to calculate AND between the read request and the read request arbitration result. Note that the judgment may be made at earlier stages.

The write counter A 602 and the read counter A 603 both are a 6-bit counter. The write counter A 602 and the read counter A 603 are incremented from 000000 to 111111, and when next writing or reading is performed in a state of 111111, the state returns to 000000. These counters output counter values to the occupancy managing circuit A 604. In addition, the counter values of the read counter A 603 and the write counter A 602 each are used as lower 6 bits between a read address used for reading the data of the data stream A from the buffer memory 401 and a write address used for writing the data to the buffer memory 401.

The occupancy managing circuit A 604 references the counter value of the write counter A 602. In the case where the counter value is 000000, as it is necessary to newly occupy a region, the occupancy managing circuit A 604 references the occupancy status outputted from the flag managing circuit 501 and determines one of unoccupied regions as the region to be occupied next for the data stream A. At this time, as long as a region is unoccupied, any region may be selected, and a value of partial bit sequence having 4 bits which indicates the selected region is outputted as an occupancy value to the FIFO memory A 601. The occupancy managing circuit A 604 outputs an occupancy signal to the FIFO memory A 601 based on the write request of the data stream A, and the FIFO memory A 601 stores the 4-bit value which indicates the occupied region. The occupancy managing circuit A 604 notifies the flag managing circuit 501 of new occupation of the region and the 4-bit value which indicates the occupied region, using a flag update request.

Furthermore, the occupancy managing circuit A 604 receives the counter value from the read counter A 603 and the value held in the location indicated by the read pointer from the FIFO memory A 601. At this time, in the case where the value of the read counter A 603 is reset from 111111 to 000000 with the read request of the data stream A, the occupancy managing circuit A 604 notifies the flag managing circuit 501 of the value held in the location indicated by the read pointer and an end of the reading of data from the region indicated by the value, using the flag update request, and at the same time outputs an opening signal to the FIFO memory A 601. In addition, the same applies to a case where the reading of all data from the buffer memory 401 is ended.

Further, the occupancy managing circuit A 604 receives the FIFO control signal from the FIFO memory A 601. Free space to which the data of the data stream A can be written is calculated based on the received FIFO control signal and the counter values received from the write counter A 602 and the read counter A 603, and the calculated free space is outputted to the write request arbitration circuit 403. Simultaneously, an amount of remaining data in the buffer memory 401 is calculated, and the calculated amount of remaining data is outputted to the read request arbitration circuit 404.

As stated above, the occupancy managing circuit A 604 causes the FIFO memory A 601 to store a value of a first bit sequence corresponding to a flag indicating an unoccupied state, in the where writing of data to a region is completed and there is data to be written.

The selector 605 selects either the occupancy value outputted from the occupancy managing circuit A 604 or the value held in the location immediately previous to the location indicated by the write pointer, the value being outputted from the FIFO memory A 601. In the case where the occupancy signal is outputted from the occupancy managing circuit A 604, the occupancy value is selected; and the value held in the location immediately previous to the location indicated by the write pointer is selected in other cases. This is because the FIFO memory A 601 is to require one cycle to hold the occupancy value outputted from the occupancy managing circuit A 604 at a time of newly occupying the region. At this time, an output signal of the selector 605 is upper 4 bits of the write address of the data stream A.

It should be noted that an operation of the address generating circuit B 503 which generates an address of the data stream B is same as that of the address generating circuit A 502.

The following describes an operation of the buffer memory sharing apparatus in the present embodiment using a specific example. Especially, an operation for occupying a new region and an operation for opening a region from which all of the data are read will be described.

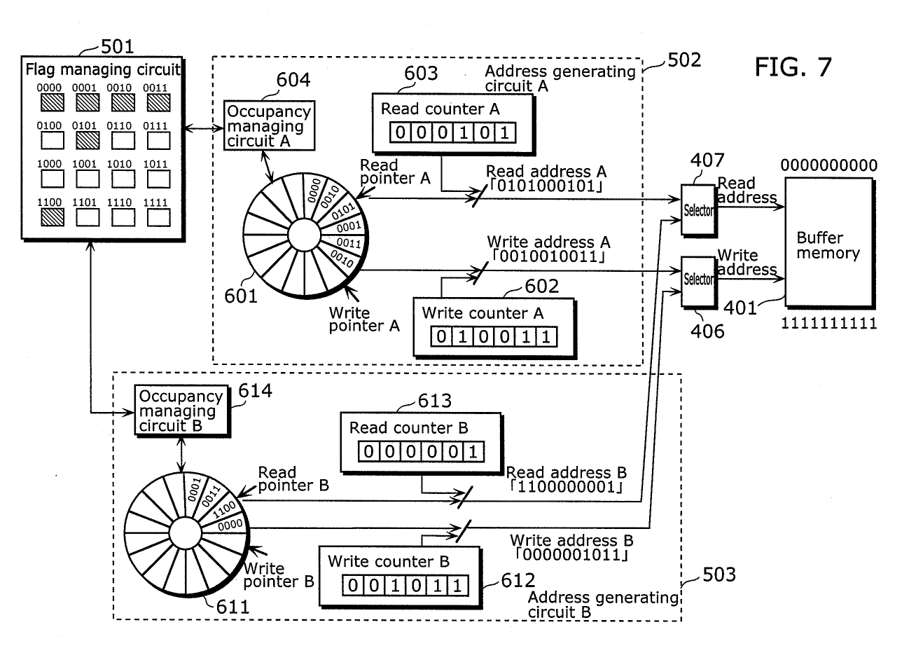

FIG. 7 is a diagram for describing the operation of the buffer memory sharing apparatus according to the present embodiment. The address generating circuit A 502 in the figure generates a write address A and a read address A for reading and writing the data of the data stream A. The address generating circuit B 503 generates a write address B and a read address B for reading and writing the data of the data stream B. It should be noted that, as stated above, the respective structures of the address generating circuit A 502 and the address generating circuit B 503 are same. As shown in FIG. 7, the address generating circuit B 503 includes a FIFO memory B 611, a write counter B 612, a read counter B 613, and an occupancy managing circuit B 614. The FIFO memory B 611, the write counter B 612, the read counter B 613, and the occupancy managing circuit B 614 each operate in the same manner as the above-mentioned FIFO memory A 601, the write counter A 602, the read counter A 603, and the occupancy managing circuit A 604.

Several regions among the regions obtained by dividing the buffer memory 401 into 16 equal parts are exclusively allocated to the FIFO memory A 601 and the FIFO memory B 611 respectively. In an example shown in FIG. 7, four regions whose partial bit sequences are 0010, 0011, 0001, and 0101 are allocated to the FIFO memory A 601. Two regions whose partial bit sequences are 0000 and 1100 are allocated to the FIFO memory B 611. As it is considered that the regions allocated to the FIFO memory A 601 and the FIFO memory B 611 are occupied for the data stream A and the data stream B, flags of the six regions whose partial bit sequences are 0000, 0001, 0010, 0011, 0101, and 1100 indicate the occupied state.

Here, first, reading of the data of the data stream A will be described.

In the case of reading the data of the data stream A, the address generating circuit A 502 generates a 10-bit read address A by combining a 4-bit value indicated by the read pointer A of the FIFO memory A 601 and a 6-bit value outputted from the read counter A 603. In the example shown in the figure, 0101000101 is generated as the 10-bit read address A by combining 0101 and 000101.

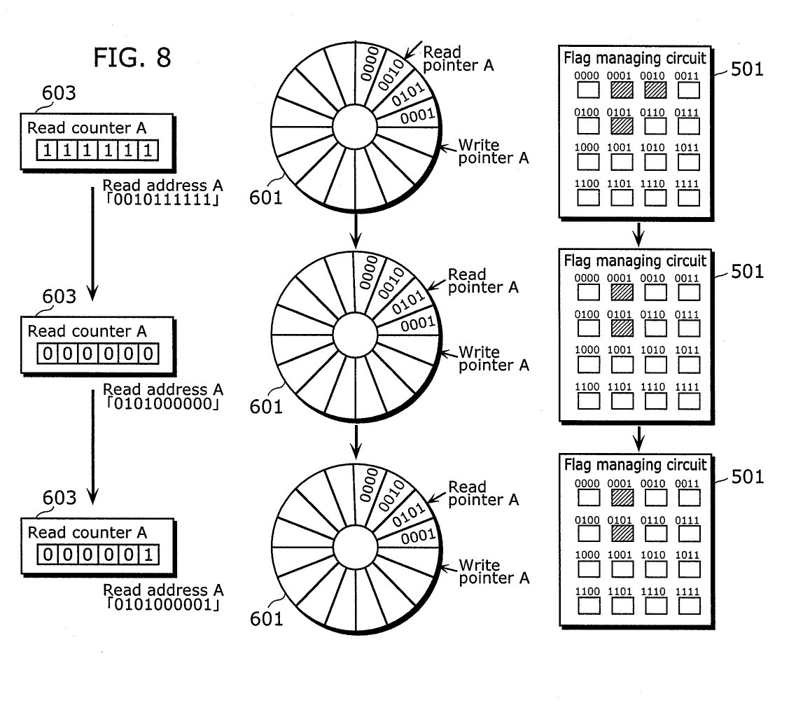

FIG. 8 is a diagram for describing the operation regarding generation of a read address and opening of a region.

As shown in the figure, when the counter value of the read counter A 603 is 111111, the 4-bit value 0010 indicated by the read pointer A and 111111 are combined, and 0010111111 is outputted as a read address A. Having reached the maximum value, the read counter A 603 is reset to 000000 which is an initial value. At the same time, the read pointer A moves in a fixed direction (here clockwise). Further, at the same time, the occupancy managing circuit A 604 (not shown in FIG. 8) outputs, to the flag managing circuit 501, a flag update request which indicates the opening of the region. The flag managing circuit 501 receives the flag update request and changes 0010 to the unoccupied state.

As stated above, when 0010111111 is generated as the read address A and the data is read, then 0101000000 is to be generated as a read address A and data is to be read. Subsequently, in the same manner, as the read counter A 603 is incremented, the data is sequentially read from the buffer memory 401.

Next, writing of the data of the data stream A will be described.

In the case of writing the data of the data stream A, the address generating circuit A 502 generates a 10-bit write address A by combining a 4-bit value held in a location immediately previous to a location indicated by the write pointer A of the FIFO memory A 601 and a 6-bit value outputted from the write counter A 602. In the example shown in FIG. 7, 0010010011 is generated as the 10-bit read address A by combining 0010 and 10011.

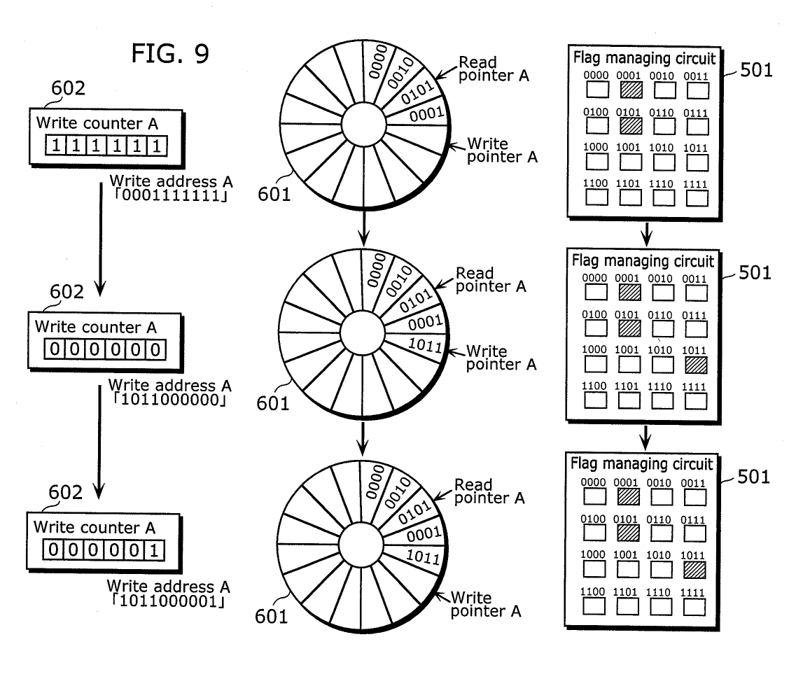

FIG. 9 is a diagram for describing the operation regarding generation of a write address and occupancy of a region.

As shown in the figure, when the counter value of the write counter A 603 is 111111, the 4-bit value 0001 held in the location immediately previous to the location indicated by the write pointer A and 111111 are combined, and 0001111111 is outputted as a write address A. Having reached the maximum value, the write counter A 602 is reset to 000000 which is an initial value.

Here, in the case where the writing of the data of the data stream A continues, the occupancy managing circuit A 604 (not shown in FIG. 9) selects an unoccupied region by referencing the flag shown by the flag managing circuit 501, and makes a 4-bit value indicating the selected region stored in the location indicated by the write pointer of the FIFO memory A 601.

For example, in the case where a 4-bit value indicating the newly selected unoccupied region is 1011, 1011 is written at the location indicated by the write pointer A of the FIFO memory A 601. At the same time, the address generating circuit A 502 combines 1011 and 000000, and generates 1011000000 as a 10-bit write address A. In addition, the flag managing circuit 501 changes 1011 to the occupied state.

When the FIFO memory A 601 writes 1011 at the location indicated by the write pointer A, the FIFO memory A 601 moves the write pointer A to a fixed direction (here clockwise). Subsequently, in the same manner, as the write counter A 602 is incremented, the data is sequentially written to the buffer memory 401.

It should be noted that the same applies to the case of reading or writing the data of the data stream B.

As described above, the buffer memory sharing apparatus according to the present embodiment can indicate the location to which the data is written and the location from which the data is read by managing the addresses each of which specifies the location in the buffer memory using the FIFO memories and the counters. That is to say, managing and controlling the free space in the buffer memory and the occupied regions are simple and easy.

Therefore, when the respective variable amount ring buffers are formed on the same buffer memory for each data stream, the expansion or contraction of the region is not restricted by the respective write pointers and read pointers. This allows the space efficiency of the buffer memory to be always maintained at high level.

### Second Embodiment

A buffer memory sharing apparatus of the present embodiment is an apparatus which limits the number of regions to be allocated for each data stream so as to facilitate estimation of transfer performance of a data stream and the like.

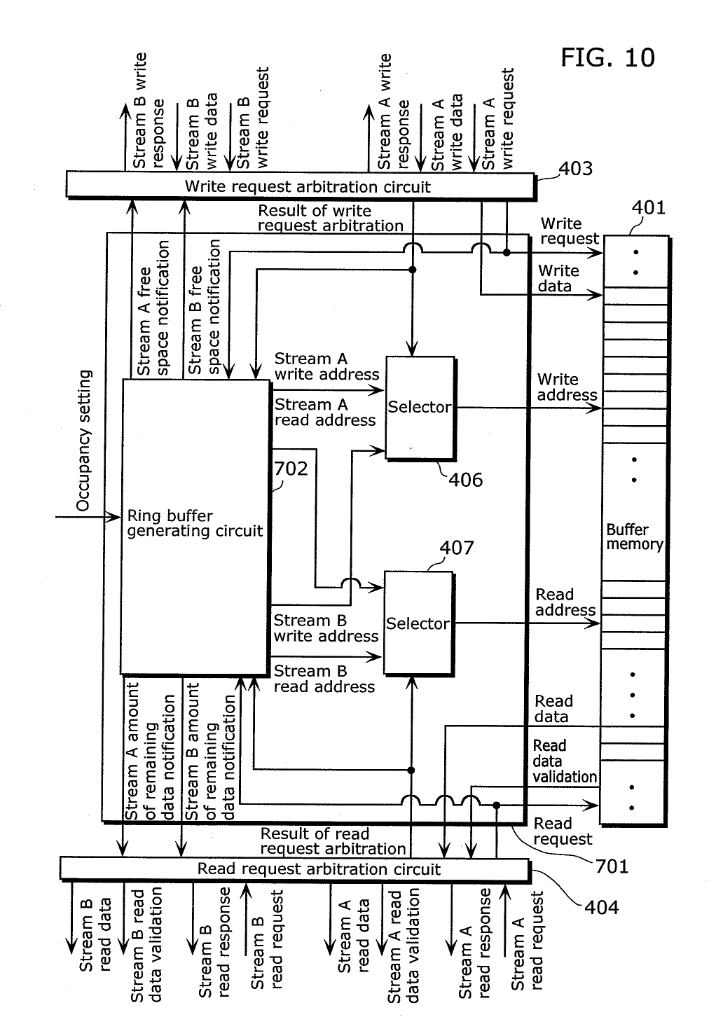

FIG. 10 is a block diagram showing a structure of the buffer memory sharing apparatus according to the present embodiment.

In comparison with the buffer memory sharing apparatus of the first embodiment, the buffer memory sharing apparatus of the present embodiment differs in that a control circuit 701 is included instead of the control circuit 402. The following mainly describes not the same point but the different point.

In addition to the operation of the control circuit 402, the control circuit 701 further accepts an occupancy setting from the outside. The occupancy setting is an instruction for specifying how many buffer regions of the buffer memory 401 are to be occupied by data stream A and data stream B respectively.

To perform the above process, the control circuit 701 includes a ring buffer generating circuit 702 and the selectors 406 and 407.

In addition to the operation of the ring buffer generating circuit 405, the ring buffer generating circuit 702 accepts an external occupancy setting.

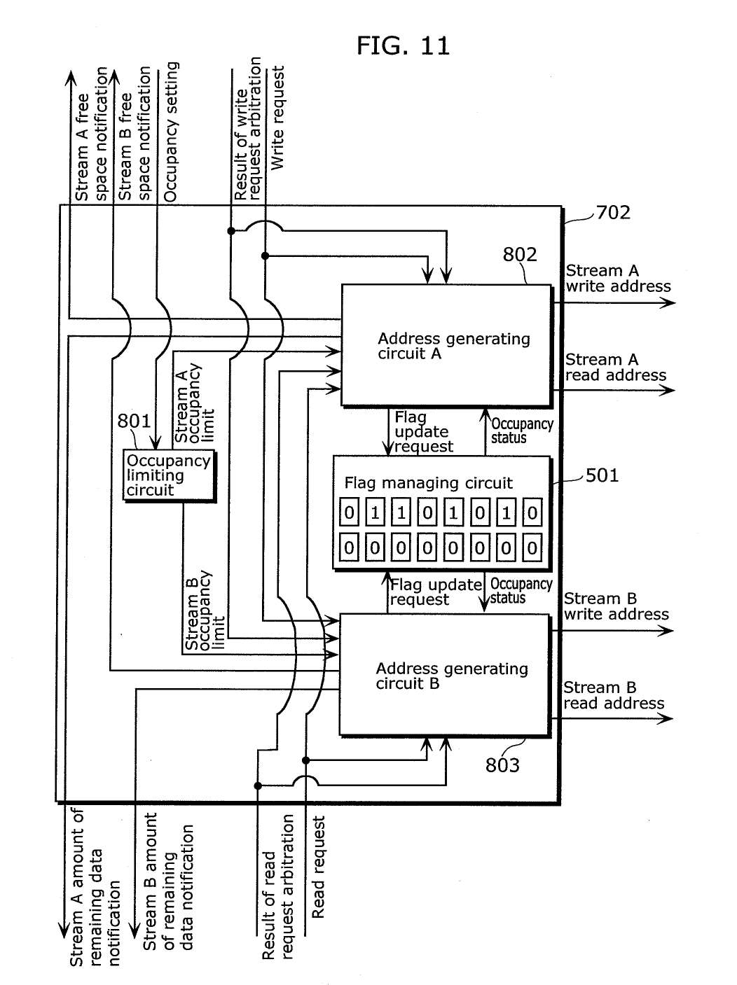

FIG. 11 is a block diagram showing a structure of the ring buffer generating circuit 702.

As shown in the figure, the ring buffer generating circuit 702 includes the flag managing circuit 501, an occupancy limiting circuit 801, an address generating circuit A 802, and an address generating circuit B 803.

Upon receiving an occupancy setting, the occupancy limiting circuit 801 calculates an upper limit for the number of regions to be allocated to the data stream A and the data stream B, and outputs the calculated upper limit to the address generating circuit A 802 and the address generating circuit B 803.

A lower limit for the number of regions to be allocated to the data stream A and the data stream B is, for example, given to the occupancy limiting circuit 801 by a control circuit such as an external CPU and the like. For example, in the case where it is set that, among sixteen values which a partial bit sequence can indicate, at least three are occupied by the data stream A and at least five are occupied by the data stream B, there is a value which sixteen partial bit sequences in total can indicate in the present embodiment, and an upper limit value assigned to the data stream A is 11 (=16-5) and an upper limit value assigned to the data stream B is 13 (=16-3) so that the value is efficiently used by the two data streams.

The occupancy limiting circuit 801 calculates each upper limit value and outputs each of the calculated upper limit values in this manner. It should be noted that setting of an occupancy limit is not limited to this example, and, for example, au upper limit value assigned to each data stream may be given from the beginning. Although the buffer memory 401 is divided into equal-sized regions to be occupied by exclusively occupying a value of a partial bit sequence on an address line, the value being to be outputted to the buffer memory 401, a feature of the present invention is that allocation of the regions of the buffer memory 401 is easily and simply controlled on a basis of region to be occupied.

In addition to the operation of the address generating circuit A 502, as mentioned above, the address generating circuit A 802 further allocates regions according to the occupancy limit (upper limit value) of the data stream A to be inputted from the occupancy limiting circuit 801. A process of allocating the regions according to the occupancy limit will be described later.

The address generating circuit B 803 has the same structure as the address generating circuit A 802.

Next, a process in the case where the address generating circuit A 802 and the address generating circuit B 803 accept an occupancy limit of each data stream will be described. Note that, as the address generating circuit A 802 and the address generating circuit B 803 perform the same operation, the address generating circuit A 802 will be described as an example here.

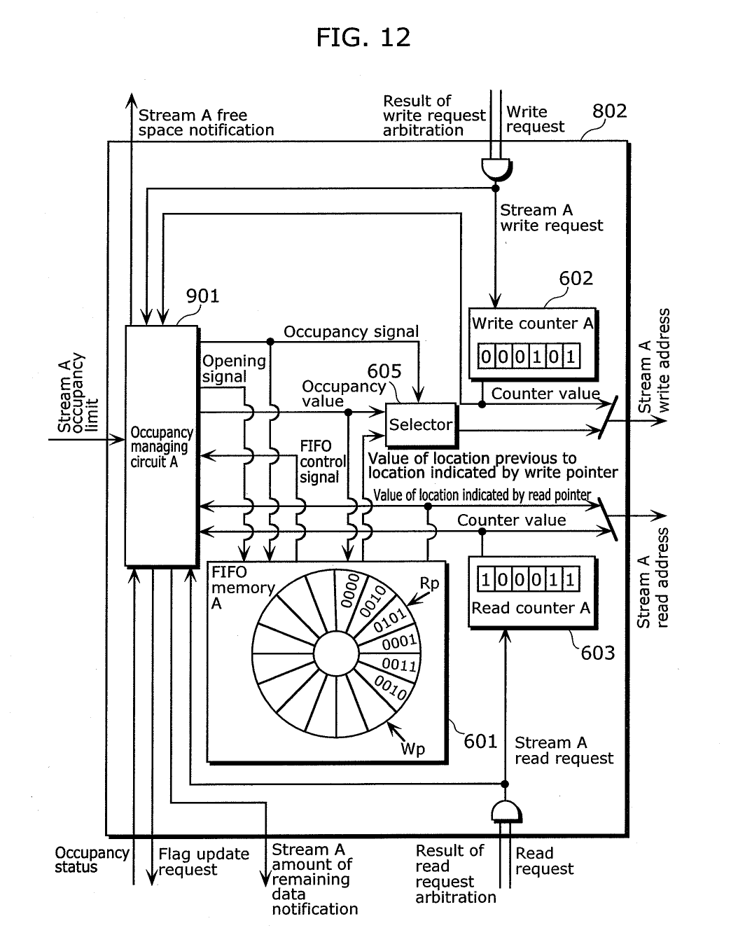

FIG. 12 is a block diagram showing the structure of the address generating circuit A 802.

As shown in FIG. 12, the address generating circuit A 802 includes an occupancy managing circuit A 901, the FIFO memory A 601, the write counter A 602, the read counter A 603, and the selector 605.

Upon receiving an occupancy limit of the data stream A, the occupancy managing circuit A 901 limits the number of regions to be occupied to equal to or more than a value indicated by the occupancy limit. Although, similar to the occupancy managing circuit A 604, the occupancy managing circuit A 901 outputs a value indicated by free space of the data stream A, the value outputted at this time is limited to equal to or less than free space calculated based on the value indicated by the occupancy limit. For example, an occupancy limit is assumed as 11 here. As the buffer memory 401 has 1024 locations, 64 locations come to be occupied by occupying one value among sixteen values that a partial bit sequence can indicate. Accordingly, the maximum value of the locations that can be occupied by the data stream is 704 (=64×11). At this time, even when the free space of the data stream A calculated based on the occupancy status outputted from the flag managing circuit 501, the FIFO control signal outputted from the FIFO memory A 601, and the counter values outputted from the write counter A 602 and the read counter A 603 is greater than 704, the value to be outputted as free space is 704.

Other operations of the occupancy managing circuit A 901 are same as those of the occupancy managing circuit A 604. In addition, an operation of the address generating circuit B 803 which generates an address of the data stream B is same as that of the address generating circuit A 802.

These can facilitate control such as an attempt to improve the transfer performance by dynamically occupying remaining regions in turn, while assuring occupation of the minimum number of buffer memory regions for the data stream A and the data stream B.

It should be noted that, even if the number of occupied regions is greater than the value indicated by the occupancy setting at the time the occupancy setting has been updated, since it falls below the value indicated by the occupancy setting as the data transfer proceeds, setting for an occupancy limit is always possible. Specifically, it is as follows.

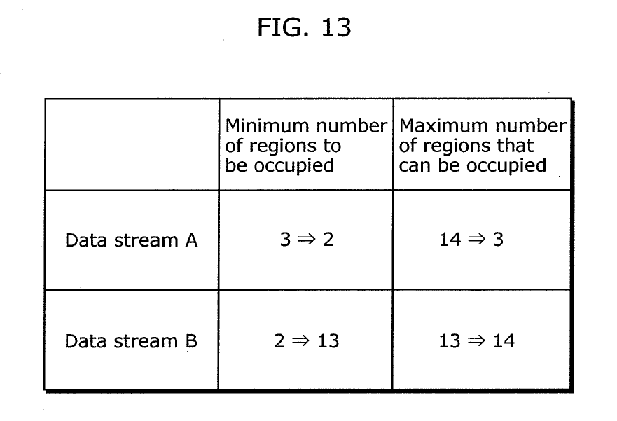

FIG. 13 is a diagram showing an example of the number of occupiable regions limited for each data stream. As shown in the figure, it is assumed that a lower limit value indicating the number of regions to be occupied by the data stream A is changed from 3 to 2 and that a lower limit value indicating the number of regions to be occupied by the data stream B is changed from 2 to 13. At this time, the occupancy limit of the data stream A is changed from 14 (=16-2) to 3 (=16-13), and that of the data stream B is changed from 13 (=16-3) to 14 (=16-2).

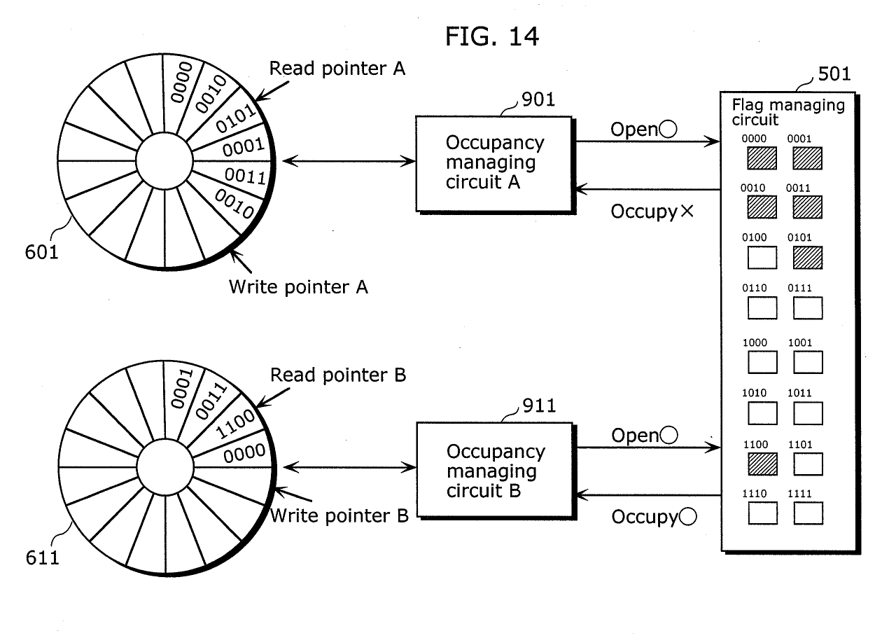

FIG. 14 is a diagram for describing an operation in the case where the number of occupiable regions limited for each data stream is changed dynamically. As shown in the figure, the FIFO memory A 601 occupies four regions whose partial bit sequences are 0010, 0011, 0001, and 0101. The FIFO memory B 611 occupies two regions of 0000 and 1100.

Here, in the case where the occupancy limits are dynamically changed as shown in FIG. 13, although the occupancy limit is 3, the data stream A occupies the four regions. Even though the write process of the data stream A proceeds and the writing of data to the whole region of 0010 is ended (that is, in the case of writing the data to 0010111111), the occupancy managing circuit A 901 prohibits occupying a new region so that the number of regions occupied by the data stream A is decreased to three. The number of regions occupied by the data stream A can be decreased to three by proceeding the read process of the data stream A, reading all of the data in the region 0101, and opening the region 0101. Subsequently, the occupancy managing circuit A 901 manages the occupation of region so that the number of regions always occupied is equal to or less than three.

As described above, according to the buffer memory sharing apparatus of the present embodiment, when the respective variable amount ring buffers are formed on the same buffer memory for each data stream, it becomes possible that the buffer memory region allocated to each data stream is dynamically changed with the simple control. Therefore, the estimation of transfer performance of each data stream also becomes easy.

### Third Embodiment

A buffer memory sharing apparatus of the present embodiment is an apparatus which can write data to a writable space in a region where a data reading process has not completed, so as to further improve space efficiency of a buffer memory.

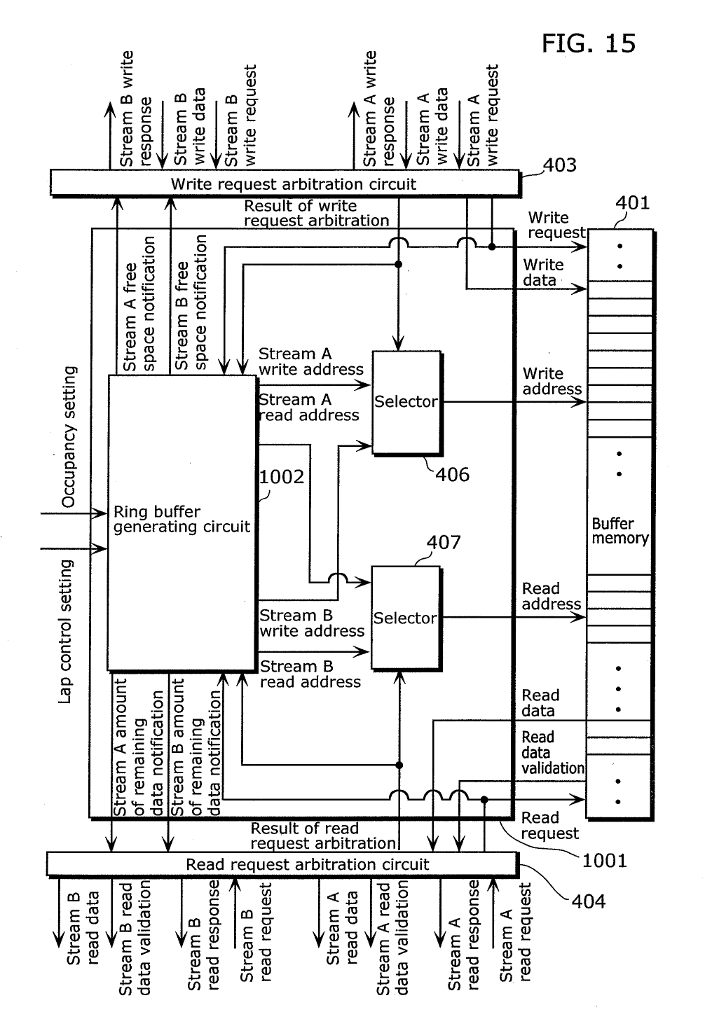

FIG. 15 is a block diagram showing a structure of the buffer memory sharing apparatus according to the present embodiment.

In comparison with the buffer memory sharing apparatus of the second embodiment, the buffer memory sharing apparatus of the present embodiment differs in that a control circuit 1001 is included instead of the control circuit 701. The following mainly describes not the same point but the different point.

In addition to the operation of the control circuit 701, the control circuit 1001 accepts, from the outside, a lap control setting for data stream A and data stream B. The lap control setting is setting information for judging whether or not a lap process is performed. It should be noted that the lap process here denotes that a write process is performed on, among regions obtained by dividing the buffer memory 401, a region to which a read process is being performed.

To perform the above process, the control circuit 1001 includes a ring buffer generating circuit 1002 and the selectors 406 and 407.

In addition to the operation of the ring buffer generating circuit 702, the ring buffer generating circuit 1002 performs a process regarding the lap control setting.

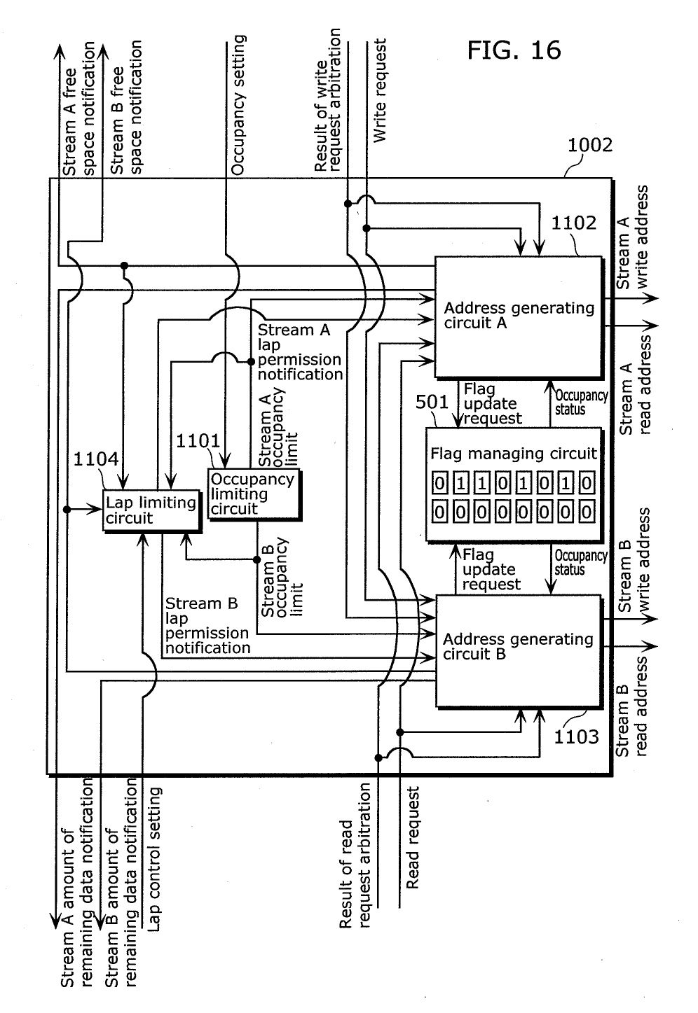

FIG. 16 is a block diagram showing a structure of the ring buffer generating circuit 1002. The ring buffer generating circuit 1002 in the figure includes the flag managing circuit 501, an occupancy limiting circuit 1101, an address generating circuit A 1102, an address generating unit B 1103, and a lap control circuit 1104.

In addition to the operation of the occupancy limiting circuit 801, the occupancy limiting circuit 1101 further outputs, to the lap control circuit 1104, occupancy limits for the data stream A and the data stream B.

In addition to the operations of the address generating circuit A 802 and the address generating circuit B 803, the address generating circuit A 1102 and the address generating circuit B 1103 receive, from the lap control circuit 1104, lap permission notifications for the data stream A and the data stream B respectively. A process in the case of receiving the lap permission notifications will be described later.

The lap control circuit 1104 accepts lap control setting by a control circuit such as an external CPU. Moreover, the lap control circuit 1104 references: the occupancy limits for the data stream A and the data stream B outputted from the occupancy limiting circuit 1101; a notification of data stream A's free space outputted from the address generating circuit A 1102; and a notification of data stream B's free space outputted from the address generating circuit B 1103. The lap control circuit 1104 judges whether the lap process of the data stream A and the lap process of the data stream B are appropriate based on these, and outputs the lap permission notifications to the address generating circuit A 1102 and the address generating circuit B 1103 respectively, in the case where it is judged appropriate.

Here, for example, in the case where, although it is attempted to newly occupy a region as the data stream A's free space is used up, a new region cannot be occupied since the occupancy limit has been reached, the lap control circuit 1104 judges that lapping is appropriate and outputs the lap permission notification for the data stream A.

Note that a method for judging the lap process is not limited to the above method. For example, in the case where an amount of data to be inputted or to be outputted is known in advance, it is also possible to add this to criteria for the judgment. Furthermore, it is possible to monitor a speed of inputting or outputting data of each data stream, and to judge whether it is better to lap in view of these monitored speed.

Next, a process in the case where the address generating circuit A 1102 and the address generating circuit B 1103 each accept the lap permission notification will be described. It should be noted that, as the address generating circuit A 1102 and the address generating circuit B 1103 perform the same operation, the address generating circuit A 1102 will be described as an example here.

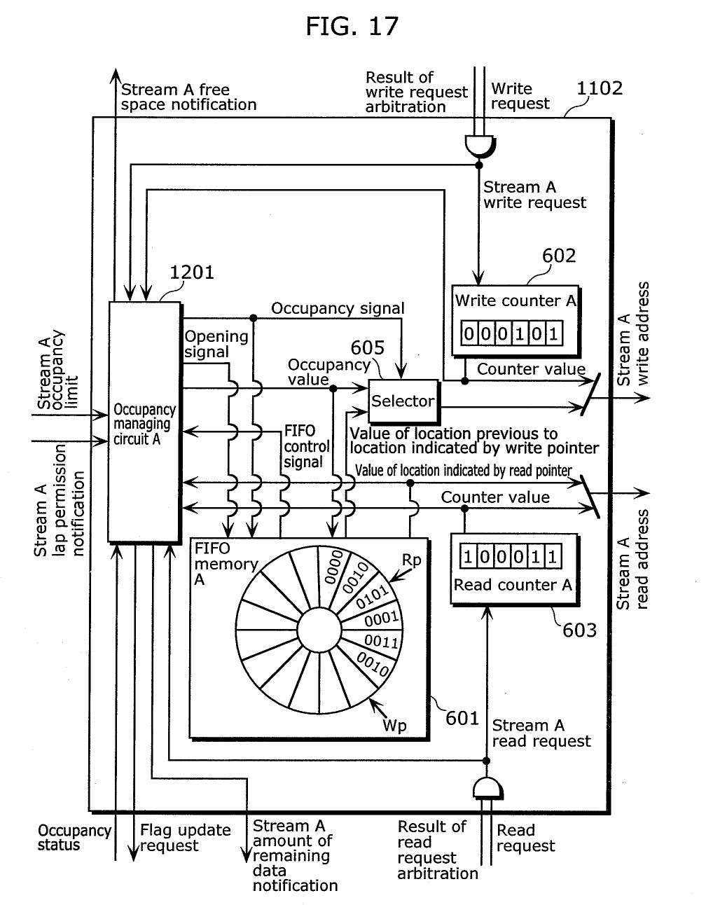

FIG. 17 is a block diagram showing the structure of the address generating circuit A 1102.

As shown in FIG. 17, the address generating circuit A 1102 includes an occupancy managing circuit A 1201, the FIFO memory A 601, the write counter A 602, the read counter A 603, and the selector 605.

Upon receiving the lap permission notification for the data stream A, the occupancy managing circuit A 1201 references the lap permission notification in the case where the data stream A's free space is used up. In the case where the lap process is permitted by the lap permission notification, the occupancy managing circuit A 1201 outputs, as an occupancy value, a value held in a location indicated by the read pointer of the FIFO memory A 601 so that a region can be newly occupied. For example, in FIG. 17, the value held in the location indicated by the read pointer is 0101. At this time, although a flag that indicates an occupancy status of a partial bit sequence value 0101 of the flag managing circuit 501 indicates an occupied state, the occupancy managing circuit A 1201 outputs 0101 as the occupancy value. Moreover, in the case the partial bit sequence value 0101 is occupied again, a value of the free space to which the data of the data stream can be written (equivalent to a counter value of the read counter A 603) is outputted as a notification of free space. In this condition, in the case where a write request of the data stream A is inputted, the occupancy value 0101 is outputted as upper 4 bits of a write address and stored in the FIFO memory A 601. At this time, for comparison, lower 6 bits of the write address is a counter value 000000 of the write counter A 602.

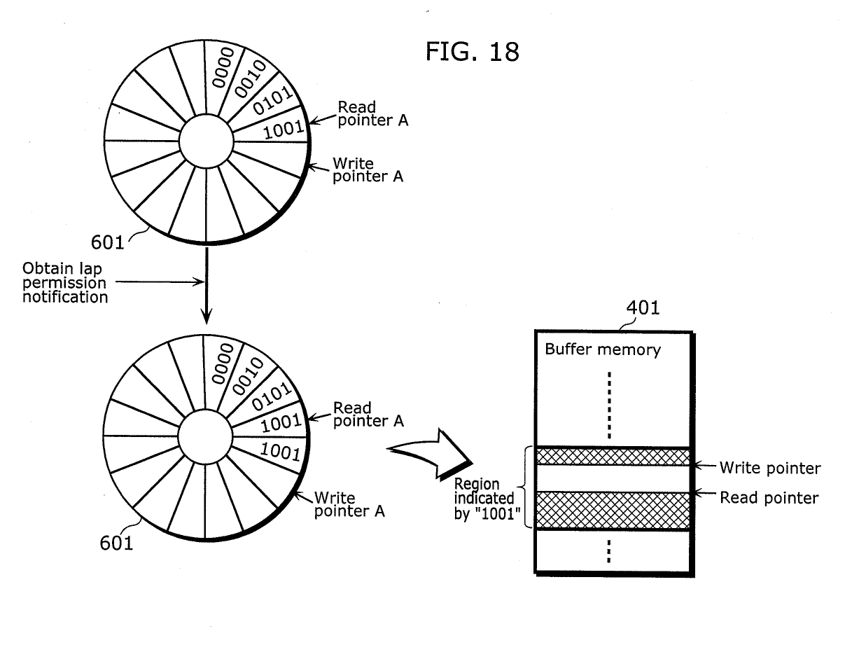

FIG. 18 is a view showing a frame format for describing the above operation more specifically. In the case where a new region cannot be occupied for the data stream A, the occupancy managing circuit A 1201 stores, in the case of receiving the lap permission notification, a 4-bit value indicated by the read pointer A in a location indicated by the write pointer A of the FIFO memory A 601. In an example shown in FIG. 18, 1001 is stored in the location indicated by the write pointer A, and the write pointer A moves clockwise.

As a result, the read pointer and the write pointer exist in the region indicated by the partial bit sequence value 1001 in the buffer memory 401. Thus, it is necessary to control so as to prevent writing new data on data that is not read.

After lapping is performed as mentioned above, the counter value of the write counter A 602 never becomes greater than the counter value of the read counter A 603 in a period during which the value held in the location indicated by the read pointer A of the FIFO memory A 601 and the value held in the location immediately previous to the location indicated by the write pointer A are equal. That is, an output by the write counter A 602 is suspended in the case where the counter value of the write counter A 602 becomes equal to the counter value of the read counter A 603. This is not only because the write request arbitration circuit 403 arbitrates the write request in consideration of the free space outputted from the ring buffer generating circuit 1002 but also because the arbitration allows a ring buffer to be controlled so as not to overflow. In addition, this denotes that writing is limited by progress in reading once the lapping is performed. However, regions distantly located on the buffer memory 401 are controlled as one ring buffer region in the present embodiment. Therefore, in comparison with the techniques described in Patent References 1 to 3, it is less likely that the writing is limited by the progress in reading after the lapping is performed, and, even if it were to be limited, a period in which the writing is limited is short and restrictive.

Moreover, even if, after the lapping is performed, the counter value of the read counter A 603 is updated from 111111 to 000000 in a period during which the value held in the location indicated by the read pointer and the value held in the location immediately previous to the location indicated by the write pointer are equal, the occupancy managing circuit A 1201 does not output, to the flag managing circuit 501, a flag update request which notifies opening of the occupied region where the value of the partial bit sequence is indicated by the partial bit sequence value 0101. This is because the occupied region where the value of the partial bit sequence is indicated by the partial bit sequence value 0101 is occupied again by performing the lapping.

In addition, an operation of the address generating circuit B 1103 which generates an address of the data stream B is same as that of the address generating circuit A 1102.

As described above, according to the buffer memory sharing apparatus of the present embodiment, when the respective variable amount ring buffers are formed on the same buffer memory for the data streams, it becomes possible to judge whether the expansion of each region is continued or stopped according to a set policy or current circumstances. Consequently, the space efficiency of the buffer memory can be improved.

### Fourth Embodiment

A buffer memory sharing apparatus of the present embodiment is an apparatus which allows a partial bit sequence indicating a buffer memory region to be shared for data streams so that memory resources of a buffer memory which is used for management of regions are used effectively. The buffer memory sharing apparatus of the present embodiment basically has the same structure as the buffer memory sharing apparatus described in the first to third embodiments, but differs in that a process of managing allocation of regions obtained by dividing the buffer memory. The following describes in detail a FIFO memory which manages the allocation of regions, and other points are not described.

In the present embodiment, as an example, a buffer memory which is divided into 64 regions (=26) is shared for three data streams, data stream A, data stream B, and data stream C. That is to say, upper 6 bits in a 10-bit address are assumed as a partial bit sequence.

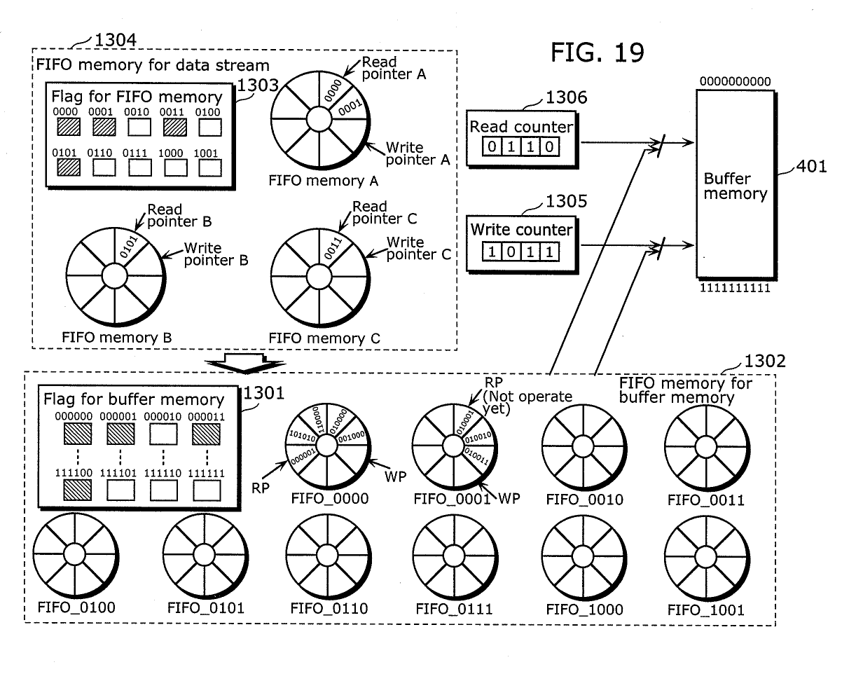

FIG. 19 is a diagram showing a structure of the FIFO memory of the buffer memory sharing apparatus according to the present embodiment.

Flag for buffer memory 1301 includes 64 flags for displaying occupancy statuses for values that the upper 6-bit partial bit sequence can indicate. That is to say, each of them is a flag reflecting an occupancy status for one of equal-sized regions which is accessed with 000000, 000001, 000010, 000011, . . . , 111100, 111101, 111110, and 111111. The flag for buffer memory 1301 is managed by the flag managing circuit 501.

FIFO memory for buffer memory 1302 includes FIFO memories in which the values of the partial bit sequence, that is, equal-sized regions are stored. Here, as an example, the buffer memory sharing apparatus includes 10 FIFO memories to which 8 pieces of data can be written. In the present embodiment, these 10 FIFO memories are occupied for each data stream. It should be noted that the inclusion of 10 FIFO memories to which the 8 pieces of data can be written enables 80 pieces of data in total (=8×10) to be stored (in the present embodiment, allowing for 64 flags).

Each of the 10 FIFO memories is assigned with one of ID numbers as follows: FIFO_{—}0000, FIFO_{—}0001, FIFO_{—}0010, FIFO_{—}0011, FIFO_{—}0100, FIFO_{—}0101, FIFO_{—}0110, FIFO_{—}0111, FIFO_{—}1000, and FIFO_{—}1001.

Flags for FIFO memory 1303 are flags for indicating occupancy statuses of the 10 FIFO memories included in the FIFO memory for buffer memory 1302. The flags for FIFO memory 1302 are, for example, managed by the flag managing circuit 501.

FIFO memory for data stream 1304 includes FIFO memories each of which is for each data stream in which an ID number of a FIFO memory is stored. Here, the data stream A, the data stream B, and the data stream C are provided with a FIFO memory A, a FIFO memory B, and a FIFO memory C, respectively. The FIFO memory for data stream 1304 includes an address generating circuit for each data stream (that is, equivalent to the FIFO memory A 601 of the first embodiment and the like).

A write counter 1305 is, for example, a counter which performs the same operation as the write counter A 602. Note that only a point that a counter value to be outputted is 4 bits differs.

A read counter 1306 is, for example, a counter which performs the same operation as the read counter A 603. Note that only a point that a counter value to be outputted is 4 bits differs.

As stated above, in the present embodiment, the partial bit sequence indicating the regions obtained by dividing the buffer memory is not exclusively stored, for each data stream, in the FIFO memory, but the FIFO memory in which the partial bit sequence is stored is exclusively stored, for each data stream, in the FIFO memory. In other words, it is necessary to reference the FIFO memory twice to generate an address.

The following describes, as an example, an operation regarding generation of a write address and a read address of the data stream A. Further, an operation for newly occupying a region and opening will be described.

First, a case where data of the data stream A is written to the buffer memory 401 and a case where it is not necessary to newly occupy a region (that is, a value of the write counter 1305 is not 0000) will be described. At this time, 0100111011 is generated as a 10-bit write address by combining a value 010011 immediately previous to a value indicated by a write pointer of a FIFO memory (FIFO_{—}0001) indicated by a value 0001 immediately previous to a value indicated by the write pointer of the FIFO memory A and a value 1011 outputted by the write counter 1305.

In the case where it is necessary to newly occupy a region, that is, in the case where a value of the write counter 1305 is 0000, any one of partial bit sequences indicating an unoccupied region (for example, 111110) is written, by referencing the flag for buffer memory 1301, in a location indicated by the write pointer of the FIFO memory (FIFO_{—}0001) indicated by the value immediately previous to the value 0001 indicated by the write pointer A of the FIFO memory A.

However, in the case where, although it is necessary to newly occupy a region, there is no writable space in the FIFO memory (FIFO_{—}0001) indicated by the value 0001 immediately previous to the value indicated by the write pointer of the FIFO memory A, it is necessary to occupy a new FIFO memory. Specifically, this is a case where a write pointer and a read pointer of the FIFO memory (FIFO_{—}0001) indicate the same location. In this case, any one of the unoccupied FIFO memories (for example, 0111) is written, by referencing the flag for FIFO memory 1303, in a location indicated by the write pointer A of the FIFO memory A.

Next, a case where the data of the data stream A is read from the buffer memory will be described. In this case, 0000010110 is generated as a 10-bit read address by combining a value 000001 indicated by a read pointer of a FIFO memory (FIFO_{—}0000) indicated by a value 0000 indicated by the read pointer A of the FIFO memory A and a value 0110 outputted by the read counter 1306.

Moreover, an operation for reading all of the data in a region and opening a region is same as in the first to third embodiments. That is to say, the read counter 1306 is changed from 1111 to 0000, and concurrently flag update information for opening a region is outputted and a flag of the flag for buffer memory 1301 is changed to an unoccupied state.

Further, the FIFO memory to be occupied for each data stream is opened, for example, in the case where all of the data in the region stored in the FIFO memory is read. Specifically, this is a case where the read pointer is at a location immediately previous to the write pointer in the FIFO memory and the write counter 1305 and the read counter 1306 output the same value.

As stated above, the buffer memory sharing apparatus of the present embodiment enables the memory resources for managing the regions of the buffer memory to be used effectively. In particular, it is useful in the case where a buffer memory is shared for many data streams.

The following describes reasons why the memory resources can be effectively used.

In the buffer memory sharing apparatus of the first to third embodiments, the value of the partial bit sequence of the region obtained by dividing the buffer memory is stored in the FIFO memory provided for each data stream. Although there is no problem in the case where the division number for the buffer memory as well the number of data streams are small, a huge amount of the memory resources of the FIFO memory is required in the case where the division number for the buffer memory as well as the number of data streams are large.

For example, a case where the buffer memory is divided into 256 (=2⁸) regions and shared for 10 data streams is considered. With the buffer memory sharing apparatus of the first to third embodiments, 10 8-bit width FIFO memories having 256 locations are required. In this case, according to simple calculation, a flip-flop of 8×256×10=20480 bits is required.

In the buffer memory sharing apparatus of the present embodiment, as an example, it is assumed that 20 8-bit width FIFO memories having 16 locations are prepared and the FIFO memories are shared for 10 data streams so that a partial bit sequence is stored. In this case, 8×16×20=2560 bits are required for a FIFO memory for storing the partial bit sequence. 20 bits are required for 20 flags which indicate occupancy statuses of the 20 FIFO memories. As the FIFO memory for managing the 20 FIFO memories for each of the 10 data streams requires 10 5-bit (because of the 20 FIFO memories) FIFO memories having 16 locations, 5×16×10=800 bits are required. Consequently, 2560+20+800=3380 bits are required in total.

As stated above, in comparison with the buffer memory sharing apparatus of the first to third embodiments, the buffer memory sharing apparatus of the present embodiment is clearly more useful for reducing the resources. Thus, the memory resources can be effectively used.

Although the buffer memory sharing apparatus according to the present invention has been described above based on the embodiments, the present invention is not limited to the embodiments. Each embodiment to which a person with an ordinary skill in the art gives various conceivable modifications and an embodiment made by combining elements in different embodiments are included in a scope of the present invention, as long as they do not deviate from the gist of the present invention.

For example, in the case where a write address and a read address are same, a region may be opened. In other words, this is a case where there is no data to be read. Specifically, this is a case where the read pointer of the FIFO memory A is at a location immediately previous to the write pointer of the FIFO memory A, and the write counter A and the read counter B indicate the same value.

Moreover, the address generating circuit A 502 may not always include the selector 605 in the first embodiment. In this case, when a 4-bit value indicating a region to be occupied is written to the FIFO memory A 601, the write pointer of the FIFO memory A 601 is incremented. Then, a write address A is generated by combining the 4-bit value written in a location immediately previous to a location indicated by the write pointer and the counter value of the write counter A 602.

As stated above, although time for writing the value to the FIFO memory A 601 (one cycle) is required, since it is not necessary to include the selector 605, the structure can be further simplified. Note that the same applies to the other embodiments.

Since this results in that a region is occupied for each data stream only in the case where it is always necessary to occupy a region, the space efficiency of the buffer memory can be improved.

Furthermore, a part of or all components making up the buffer memory sharing apparatus according to the present invention may be made up by one system LSI. The system LSI is a super-multifunctional LSI manufactured by integrating components on one chip and, specifically, a computer system configured by including a microprocessor, a Read Only Memory (ROM), a RAM, and the like. A computer program is stored in the RAM. As the microprocessor operates according to the computer program, the system LSI performs its functions.

It should be noted that, while the buffer memory sharing apparatus writes and reads the data to and from the external buffer memory in each embodiment, a buffer memory may be included in a buffer memory sharing apparatus formed on one chip.

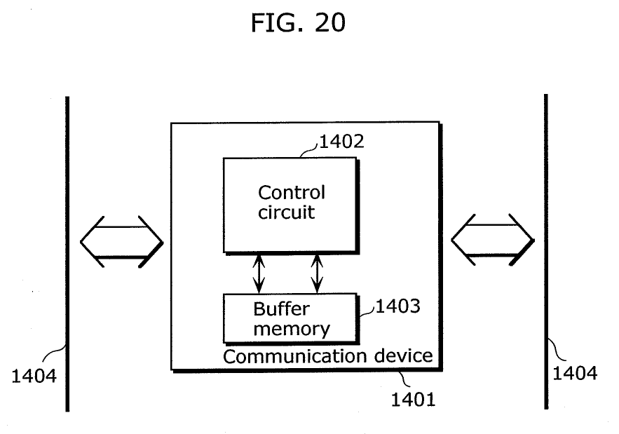

Moreover, the present invention can be realized as a communication device which transmits and receives data streams. FIG. 20 is a diagram showing a structure of the communication device including the buffer memory sharing apparatus of the present invention. As shown in the figure, a communication device 1401 includes a control circuit 1402 and a buffer memory 1403.

The control circuit 1402 transmits and receives data streams to and from a bus 1404. The control circuit 1402 temporally stores the received data streams in the buffer memory 1403. This is, for example, for narrowing a difference in a transfer speed between the data transmitting side and the data receiving side, and the like. The control circuit 1402 reads the data from the buffer memory 1403 and transmits the read data. At this time, the control circuit 1402 includes the buffer memory sharing apparatus according to the present invention so that the buffer memory 1403 is shared for the data streams.

The buffer memory 1403 is, for example, a dual port RAM which can be read and written simultaneously, and has the same structure as the buffer memory 401.

As described above, the communication device including the buffer memory sharing apparatus according to the present invention enables the space efficiency of the buffer memory to be used effectively, so that the data can be transmitted and received smoothly.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The buffer memory sharing apparatus according to the present invention is useful as an apparatus which controls buffer memories existing inside of a general semiconductor circuit, queues used for buffering data streams in a network device and so on, Static Random Access Memory (SRAM) products, and the like.

What is claimed is:

1. A buffer memory sharing apparatus which performs control so that the buffer memory is shared for data streams, said apparatus comprising:
a flag managing unit operable to manage flags each of which indicates an occupancy status of a corresponding one of regions obtained by dividing the buffer memory;
an occupancy managing unit operable to manage exclusive allocation of the regions to the data streams, based on the flags; and
an address generating unit operable to generate a write address which specifies a location in the buffer memory to which data is written and a read address which specifies a location in the buffer memory from which data is read,
wherein said address generating unit includes, in association with each the data streams:
a first First-In First-Out (FIFO) memory which stores information regarding a first bit sequence indicating a region allocated by said occupancy managing unit among first bit sequences each of which indicates a location of a corresponding one of the regions;
a write counter which outputs a second bit sequence indicating a location to which data is written, the location being in a corresponding one of the regions; and
a read counter which outputs a third bit sequence indicating a location from which data is read, the location being in a corresponding one of the regions, and
said address generating unit is operable to generate the write address by combining the second bit sequence and the first bit sequence obtained from the information stored at an end of said first FIFO memory, and to generate the read address by combining the third bit sequence and the first bit sequence obtained from the information stored at a start of said first FIFO memory.

2. The buffer memory sharing apparatus according to claim 1,
wherein said first FIFO memory stores at least one of the first bit sequences indicating the region allocated by said occupancy managing unit among the first bit sequences, and
said address generating unit is operable to generate the write address by combining the second bit sequence and the first bit sequence stored at the end of said first FIFO memory, and to generate the read address by combining the third bit sequence and the first bit sequence stored at the start of said first FIFO memory.

3. The buffer memory sharing apparatus according to claim 2,
wherein said occupancy managing unit causes said first FIFO memory to store one of the first bit sequences corresponding to a flag indicating an unoccupied state, in the case where writing of data to the region is completed, and
said flag managing unit changes, to an occupied state, the flag corresponding to the first bit sequence stored in said first FIFO memory.

4. The buffer memory sharing apparatus according to claim 3,
wherein said occupancy managing unit further causes said first FIFO memory to store one of the first bit sequences corresponding to the flag indicating the unoccupied state, in the case where there is data to be written.

5. The buffer memory sharing apparatus according to claim 4,
wherein said write counter increments a counter value every time the data is written to the region, repetitively increments from zero in the case where the counter value reaches a maximum value, and outputs the counter value as the second bit sequence, and
said occupancy managing unit causes said first FIFO memory to store one of the first bit sequences corresponding to the flag indicating the unoccupied state, in the case where the counter value of the write counter is zero and there is data to be written.

6. The buffer memory sharing apparatus according to claim 5,
wherein said address generating unit is operable to combine the first bit sequence stored in said first FIFO memory by said occupancy managing unit and the counter value of said write counter, in the case where the counter value of said write counter is zero, and to combine the first bit sequence stored at the end of said first FIFO memory and the counter value of said write counter, in the case where the counter value of said write counter is not zero.

7. The buffer memory sharing apparatus according to claim 2,
wherein said occupancy managing unit is operable to output flag update information for changing, to an unoccupied state, a flag corresponding to the region, in the case where reading of data from the region is completed, and
said flag managing unit changes the flag to the unoccupied state, in the case where the flag update information is received.

8. The buffer memory sharing apparatus according to claim 7,
wherein said read counter increments a counter value every time the data is read from the region, repeats increment from zero in the case where the counter value reaches a maximum value, and outputs the counter value as the third bit sequence, and
said occupancy managing unit is operable to output the flag update information, in the case where the counter value of the read counter becomes zero.

9. The buffer memory sharing apparatus according to claim 2,
wherein said write counter increments a counter value every time the data is written to a first region which is one of the regions, repeats increment from zero in the case where the counter value reaches a maximum value, and outputs the counter value as the second bit sequence,
said read counter increments a counter value every time the data is read from a second region which is one of the regions, repeats increment from zero in the case where the counter value reaches a maximum value, and outputs the counter value as the third bit sequence,
said occupancy managing unit causes said first FIFO memory to store one of the first bit sequences corresponding to a flag indicating an unoccupied state, in the case where the counter value of the write counter is zero and there is data to be written, and is operable to output flag update information for changing, to an unoccupied state, a flag corresponding to the second region, in the case where the counter value of the read counter becomes zero, and
said flag managing unit changes, to an occupied state, a flag corresponding to the first bit sequence stored in said first FIFO memory, and changes, to an unoccupied state, a flag corresponding to the second region in the case where the flag update information is received.

10. The buffer memory sharing apparatus according to claim 2, further comprising
an occupancy limiting unit operable to limit the number of regions to be allocated to the data stream,
wherein said occupancy managing unit is operable to manage the allocation based on the number of regions to be allocated.

11. The buffer memory sharing apparatus according to claim 10,
wherein said occupancy limiting unit is operable to dynamically determine a minimum number of regions that can be occupied for each data stream, and
said occupancy managing unit is operable to manage the exclusive allocation of the regions so as to ensure the minimum number determined for each data stream.

12. The buffer memory sharing apparatus according to claim 2, further comprising
a lap control unit operable to output a lap permission notification for controlling writing of data to a region including a location specified by the read address,
wherein said occupancy managing unit causes said first FIFO memory to store a first bit sequence indicating the region including the location specified by the read address, in the case where the lap permission notification is received.

13. The buffer memory sharing apparatus according to claim 12,
wherein said address generating unit is operable to suspend an output by said write counter, in the case where the second bit sequence outputted from said write counter becomes equal to a third bit sequence outputted from said read counter.

14. The buffer memory sharing apparatus according to claim 2,
wherein said first FIFO memory is controlled as a ring buffer having a read pointer which indicates a location from which data is read and a write pointer which indicates a location to which data is written, and
said address generating unit is operable to generate the write address by combining the second bit sequence and the first bit sequence stored at a location immediately previous to a location indicated by the write pointer of said first FIFO memory, and to generate the read address by combining the third bit sequence and the first bit sequence stored at a location indicated by the read pointer of said first FIFO memory.

15. The buffer memory sharing apparatus according to claim 1, further comprising
second FIFO memories each of which stores at least one of the first bit sequences,
wherein said flag managing unit is further operable to manage FIFO flags each of which indicates an occupancy status of a corresponding one of said corresponding second FIFO memories,
said occupancy managing unit is further operable to manage exclusive allocation of said second FIFO memories to the data streams, based on the FIFO flags,
said first FIFO memory stores, among plural identification information of said second FIFO memories, identification information allocated by said occupancy managing unit, and
said address generating unit is operable to generate the write address and the read address based on the identification information stored in said first FIFO memory.

16. The buffer memory sharing apparatus according to claim 15,
wherein said address generating unit is operable to generate the write address by combining the second bit sequence and the first bit sequence stored at an end of said second FIFO memory indicated by identification information stored at an end of said first FIFO memory and, and to generate the read address by combining the third bit sequence and the first bit sequence stored at a start of said second FIFO memory indicated by the identification information stored at a start of said first FIFO memory.

17. The buffer memory sharing apparatus according to claim 1,
wherein the first bit sequence includes an uppermost bit of the write address and the read address and is made up of bits continuing from the uppermost bit.

18. An integrated circuit for performing control so that the buffer memory is shared for data streams, said circuit comprising:
a flag managing unit operable to manage flags each of which indicates an occupancy status of a corresponding one of regions obtained by dividing the buffer memory;
an occupancy managing unit operable to manage exclusive allocation of the regions to the data streams, based on the flags; and
an address generating unit operable to generate a write address which specifies a location in the buffer memory to which data is written and a read address which specifies a location in the buffer memory from which data is read,
wherein said address generating unit includes, in association with each of the data streams:
a first FIFO memory which stores information regarding a first bit sequence indicating a region allocated by said occupancy managing unit among first bit sequences each of which indicates a location of a corresponding one of the regions;
a write counter which outputs a second bit sequence indicating a location to which data is written, the location being in a corresponding one of the regions; and
a read counter which outputs a third bit sequence indicating a location from which data is read, the location being in one of the regions, and
said address generating unit is operable to generate the write address by combining the second bit sequence and the first bit sequence obtained from the information stored at an end of said first FIFO memory, and to generate the read address by combining the third bit sequence and the first bit sequence obtained from the information stored at a start of said first FIFO memory.

19. A communication device which transmits and receives data streams, said device comprising:
a control circuit which transmits and receives the data streams; and
a buffer memory which temporally stores the data streams received by said control circuit,
wherein said control circuit includes:
a flag managing unit operable to manage flags each of which indicates an occupancy status of a corresponding one of regions obtained by dividing the buffer memory;
an occupancy managing unit operable to manage exclusive allocation of the regions to the data streams, based on the flags; and
an address generating unit operable to generate a write address which specifies a location in the buffer memory to which data is written and a read address which specifies a location in the buffer memory from which data is read,
said address generating unit includes, in association with each of the data streams:
a first FIFO memory which stores information regarding a first bit sequence indicating a region allocated by said occupancy managing unit among first bit sequences each of which indicates a location of one of the regions;
a write counter which outputs a second bit sequence indicating a location to which data is written, the location being in a corresponding one of the regions; and
a read counter which outputs a third bit sequence indicating a location from which data is read, the location being in a corresponding one of the regions, and
said address generating unit is operable to generate the write address by combining the second bit sequence and the first bit sequence obtained from the information stored at an end of said first FIFO memory, and to generate the read address by combining the third bit sequence and the first bit sequence obtained from the information stored at a start of said first FIFO memory.
